(19) United States
(12) Patent Application Publication
(10) Pub. No.: US 2015/0095082 A1
(43) Pub. Date: Apr. 2, 2015

(54) SYSTEM FOR MANAGING TASKS AND METHODS THEREOF

(71) Applicants: Ed Guntin, Barrington, IL (US); Andrew Gust, Port St. Lucie, FL (US)

(72) Inventors: Ed Guntin, Barrington, IL (US); Andrew Gust, Port St. Lucie, FL (US)

(21) Appl. No.: 14/504,337

(22) Filed: Oct. 1, 2014

Related U.S. Application Data
(60) Provisional application No. 61/885,447, filed on Oct. 1, 2013.

(51) Int. Cl. G06Q 10/06

(52) U.S. Cl. CPC G06Q 10/063114
USPC 705/7.15

(57) ABSTRACT

Aspects of the subject disclosure may include, for example, a system for obtaining a table including a plurality of tasks, determining a due date for each task according to a rule associated with each task, normalizing the plurality of tasks by assigning a task value to each task of the plurality of tasks, determining a workload capacity of each of a plurality of practitioners, and updating the table by assigning a portion of the plurality of tasks to each practitioner of the plurality of practitioners according to the workload capacity of each practitioner, the due date of each task, and the task value of each task. The task value can be based on a first factor of a unit of measure, and the workload capacity can be based on a second factor of the unit of measure. Other embodiments are disclosed.

### CROSS-REFERENCE TO RELATED APPLICATION(S)

The present application claims the benefit of priority to U.S. Provisional Application No. 61/885,447 filed on Oct. 1, 2013, which is hereby incorporated herein by reference in its entirety.

### FIELD OF THE DISCLOSURE

The subject disclosure relates to a system for managing tasks and methods thereof.

### BACKGROUND

To assist practitioners and/or project managers to timely complete tasks, software companies have developed and offered tools such as calendar tools integrated in an email system, docketing tools used by professionals (e.g., lawyers) for tracking matters and corresponding tasks, tools for generating Gantt or bar charts, and so on. Some organizations have also used checklists to memorialize best practices.

### BRIEF DESCRIPTION OF THE DRAWINGS

Reference will now be made to the accompanying drawings, which are not necessarily drawn to scale, and wherein:

FIG. 1 depicts example, non-limiting embodiments of a method of the subject disclosure;

FIG. 2 depicts example, non-limiting embodiments of a method of the subject disclosure;

FIG. 3 depicts example, non-limiting embodiments of a method of the subject disclosure;

FIG. 4A depicts an example, non-limiting embodiment of a table of task activities;

FIG. 4B depicts an example, non-limiting embodiment of a control file for processing the table of task activities;

FIG. 4C depicts an example, non-limiting embodiment of a matrix for processing problem tasks;

FIG. 5 depicts an example, non-limiting embodiment of unit totals per practitioner;

FIG. 6 depicts example, non-limiting embodiments of before and after workload balancing illustrations;

FIG. 7A depicts an example, non-limiting embodiment of a graphical user interface for presenting task schedules;

FIG. 7B depicts an example, non-limiting embodiment of a graphical user interface for presenting trends;

FIG. 8 depicts example, non-limiting embodiments of a method of the subject disclosure;

FIG. 9 depicts an example, non-limiting embodiment of a graphical user interface for presenting a checklist;

FIGS. 10A-10B depict example, non-limiting embodiments of a graphical user interface associated with a checklist;

FIGS. 11A, 11B, 12A, and 12B depict example, non-limiting embodiments of graphical user interfaces for tracking errors detected while processing checklists;

FIG. 13A depicts example, non-limiting embodiments of a method for performing policy-based processing of tasks;

FIG. 13B depicts an example, non-limiting embodiment of an illustration of policy-based processing of tasks;

FIG. 14 depicts an illustrative embodiment of a communication device; and

FIG. 15 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for scheduling tasks. Other embodiments are described in the subject disclosure.

One embodiment of the subject disclosure can include a system having a memory that stores executable instructions and a processor coupled thereto. Responsive to executing the instructions, the processor can perform operations including obtaining a list comprising a plurality of tasks, determining an absolute due date for each task of the plurality of tasks according to a rule associated with each task, assigning a task value to each task of the plurality of tasks, determining a workload capacity of each of a plurality of practitioners, and assigning a portion of the plurality of tasks to each practitioner of the plurality of practitioners according to the workload capacity of each practitioner, the absolute due date of each task, the task value of each task to generate an updated list, or any combination thereof. The task value can be based on a first factor of a unit of measure, while the workload capacity can be based on a second factor of the unit of measure.

One embodiment of the subject disclosure can include a machine-readable storage device that includes executable instructions. Responsive to executing the instructions by a processor comprising a circuit, the processor can perform operations including obtaining a list of a plurality of tasks associated with a plurality of client matters, determining a client due date for each task of the plurality of tasks according to a rule associated with each task, normalizing the plurality of tasks by assigning a task value to each task of the plurality of tasks, determining a workload capacity of each of a plurality of practitioners, and updating the list by assigning a portion of the plurality of tasks to each practitioner of the plurality of practitioners according to the workload capacity of each practitioner, the client due date of each task, the task value of each task, or any combination thereof. The task value can be based on a first factor of a unit of measure, while the workload capacity can be based on a second factor of the unit of measure.

One embodiment of the subject disclosure can include a method for obtaining a table comprising a plurality of tasks, determining a due date for each task of the plurality of tasks according to a rule associated with each task, normalizing the plurality of tasks by assigning a task value to each task of the plurality of tasks, wherein the task value is based on a first factor of a unit of measure, determining a workload capacity of each of a plurality of practitioners, wherein the workload capacity is based on a second factor of the unit of measure, and updating the table by assigning a portion of the plurality of tasks to each practitioner of the plurality of practitioners according to the workload capacity of each practitioner, the due date of each task, the task value of each task, or any combination thereof.

One embodiment of the subject disclosure can include a method for detecting a request to launch a checklist for reviewing an item, obtaining from the request an identifier of a client or a practitioner, obtaining a checklist logical sequence associated with the identifier of the client or the practitioner, and presenting a checklist item according to the checklist logical sequence. The method can further include detecting a user-generated response associated with the checklist item, and presenting one or more mitigation options responsive to detecting that the user-generated response is associated with an issue with the item under review. The method can also include selecting the one or more mitigation options from a list of mitigation options according to checklist item or the issue associated with the item. The method can also include providing an issuer of the checklist an option to continue processing other items in the checklist or cease processing of the checklist. The method can further include presenting a subsequent checklist item responsive to detecting that the user-generated response does not identify an issue with the item.

The method can also include tracking user-generated responses that identify issues in the checklist, and presenting the issues based on prescribed reporting periods or based on a user-generated request. The issues can be presented in the aggregate for all clients (or practitioners), or by specific client (or specific practitioner). Additionally, the method can further include detecting trends in the issues being tracked and presenting such trends for review (e.g., an uptake in certain issues or a decline of certain issues). The method can also include detecting when a checklist has been completed in whole or in part, submitting the checklist and user-generated responses to one or more parties or one or more systems, storing the checklist and user-generated responses, time-stamping the checklist and user-generated responses, identifying the issuer of the checklist, identifying a version of the checklist, or any combination thereof.

An apparatus can be adapted to perform the foregoing embodiments relating to checklists. Additionally, a machine-readable device such as a memory can be configured with instructions (e.g., software) that can be executed by a processor to perform the foregoing embodiments.

One embodiment of the subject disclosure can include a method for detecting a docketing entry in a matter, obtaining an identification of a client from a matter identifier associated with the matter, obtaining one or more client-policy activities according to the docketing entry and the identifier of the client, and launching the one or more client-policy activities.

Although the subject disclosure is not limited to patent and/or trademark prosecution, it is useful to describe how this discipline is practiced and how situations frequently arise when prosecution dockets of practitioners become imbalanced, which can lead to inefficiencies between practitioners and lost revenue opportunities for firms managing intellectual property portfolios. It will be appreciated that patent and trademark practices are described only for illustration purposes and are non-limiting to the subject disclosure, which can be applied to other disciplines that can be subject to work imbalances between practitioners. With this in mind, a general description of patent and trademark practices is presented below.

Patent and trademark matters are generally examined at ad hoc times by an examiner at a patent and trademark office. Consequently, office actions issued by the examiners arrive at unpredictable times. Office actions are typically received by a docketing group which dockets matters in a docketing system used by the law firm. Typically, matters are pre-assigned to different practitioners. The docketing system can issue reports that indicate when a response is due for each office action according to the assigned practitioner. Because of the unpredictable nature of office action issuances, the due dates for responding to the office actions tend to be ad hoc as well. Some practitioners will ask for a docketing report spanning a month or more to organize their work schedule, which can be very time consuming. Since it's not predictable when a matter will be examined by an examiner, the volume of pending office actions for one practitioner can dramatically differ from the number of pending office actions of another practitioner.

When the historic capacity of each practitioner to respond to office actions is taken into consideration, scenarios often arise when one or more practitioners are over-allocated (or over-committed) with pending office actions, while other practitioners having a low volume of pending office actions are under-allocated (or under-committed) through no fault of their own. If nothing changes between such practitioners, the practitioner with a high volume of pending office actions may not be able to draft responses on time to satisfy a client deadline and/or a deadline set by the patent and trademark office. Failure to satisfy response deadlines can disappoint clients and in some instances motivate clients to consider transferring matters to another firm. Additionally, missed deadlines can cause a delay in fee collections and in some instances reduce collections when the firm is forced to absorb extension fees when a patent office deadline is missed, and the client is unwilling to pay for such fees.

Some billing attorneys rely on the good will of practitioners to share matters to overcome workload imbalances. Unfortunately, because practitioners have an incentive to stay busy at all times, matter sharing happens infrequently between practitioners. Other billing attorneys take a more proactive approach of engaging in group or one-on-one practitioner meetings to decide how to distribute work between practitioners. This process is very time consuming for the billing attorney and associate attorneys or agents, and generally is written off as unbillable time by all parties. In a year's time, such meetings can account for a substantial amount of unbillable time, which translates to lower revenue potential for the firm and lower efficiencies for firm practitioners.

Workload imbalances such as described above can also be exacerbated by the ad hoc nature of new matter intake (e.g., new patent application and/or new trademark filing requests). Typically, clients send new matters to firms at unpredictable times and of unpredictable volume. This behavior is driven in part by intellectual property budget variations, as well as metrics monitored by clients such as, for example, new filings, new continuations, and patent and/or trademark issuances, to name a few. When new matter requests are received, the ability for a group of practitioners to promptly and efficiently respond to the demands of such new matters may be substantially constrained if the workload between practitioners is not balanced. Practitioners with a high volume of pending office actions may not be able to take on new matters. Practitioners with a low volume of pending office actions may not have the experience or expertise to take on a substantial portion of the new matters. A firm's inability to timely prepare patent applications and/or trademark applications inevitably disappoints clients, and reduces future opportunities to receive similar volume of work from such clients.

As will be shown, balancing dockets between practitioners, especially those with under-allocated dockets, can improve work product deliverables, increase fee collections, and provide a more satisfying experience for clients. A balanced workload between practitioners can also prepare a firm to take on new matters at a moment's notice. Balanced workloads also have the added benefit of increasing the skill level, throughput, and subject matter expertise of practitioners when a steady pace of work is maintained. Balanced workloads help practitioners maintain a steady pace of work that enables practitioners to achieve higher billable hours which can be linked to compensation goals.

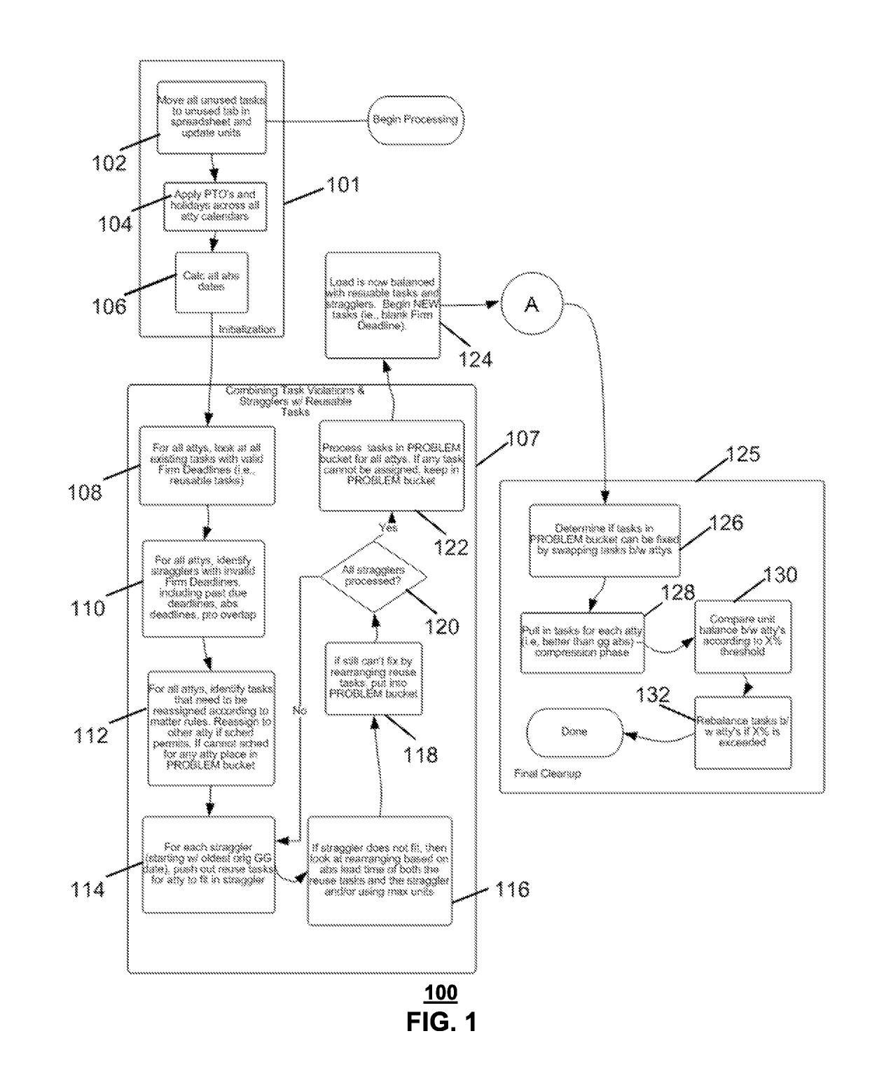

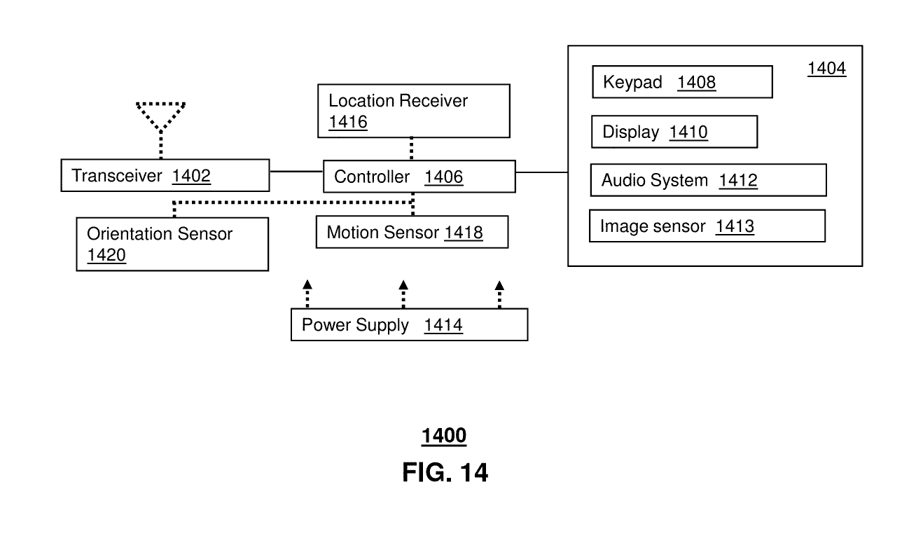

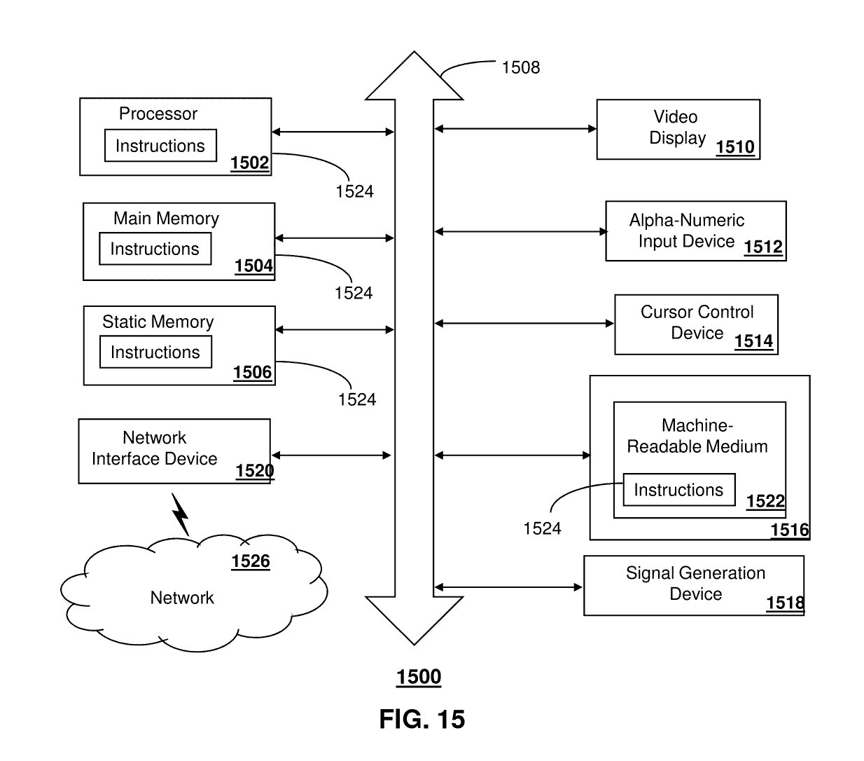

FIG. 1 depicts an example, non-limiting embodiment of a method 100 for addressing workload issues similar to those described above. Method 100 (and other methods of the subject disclosure) can be applied to disciplines other than intellectual property prosecution. For illustration purposes only, method 100 is described in relation to the processing of raw task activities generated by, for example, a docketing system. Method 100 (and other methods of the subject disclosure) can be performed by a communication device 1400 or a system 1500 such as shown in FIG. 14 or 15.

The communication device 1400 or system 1500 can be an integral part of a docketing system, or can be used independently. The communication device 1400 or system 1500 can be configured to execute instructions in accordance with the methods of the subject disclosure to process task information provided by a docketing system in relation to multiple practitioners. For illustration purposes only, system 1500 will be used to describe the methods of the subject disclosure. The communication device 1400 can also be used to perform in whole or in part the methods of the subject disclosure in place of system 1500 or in cooperation with system 1500. Variants of the embodiments of system 1500 and communication device 1400 can also be used to perform in whole or in part the methods of the subject disclosure.

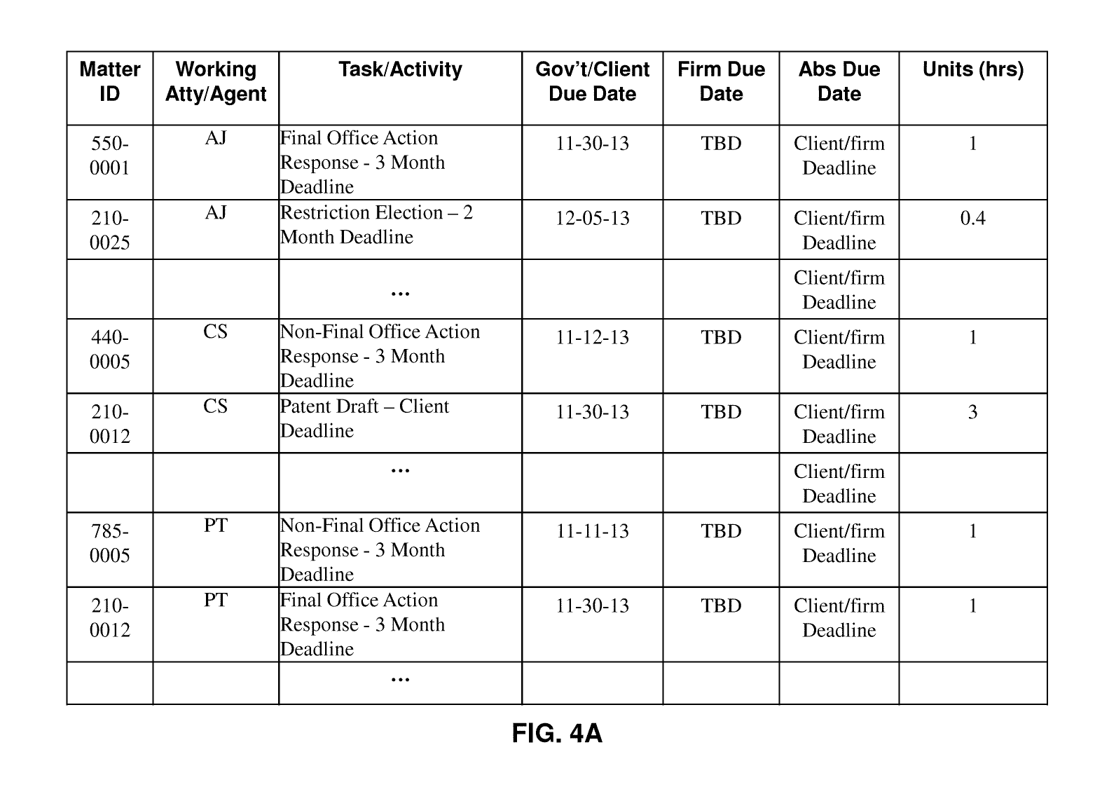

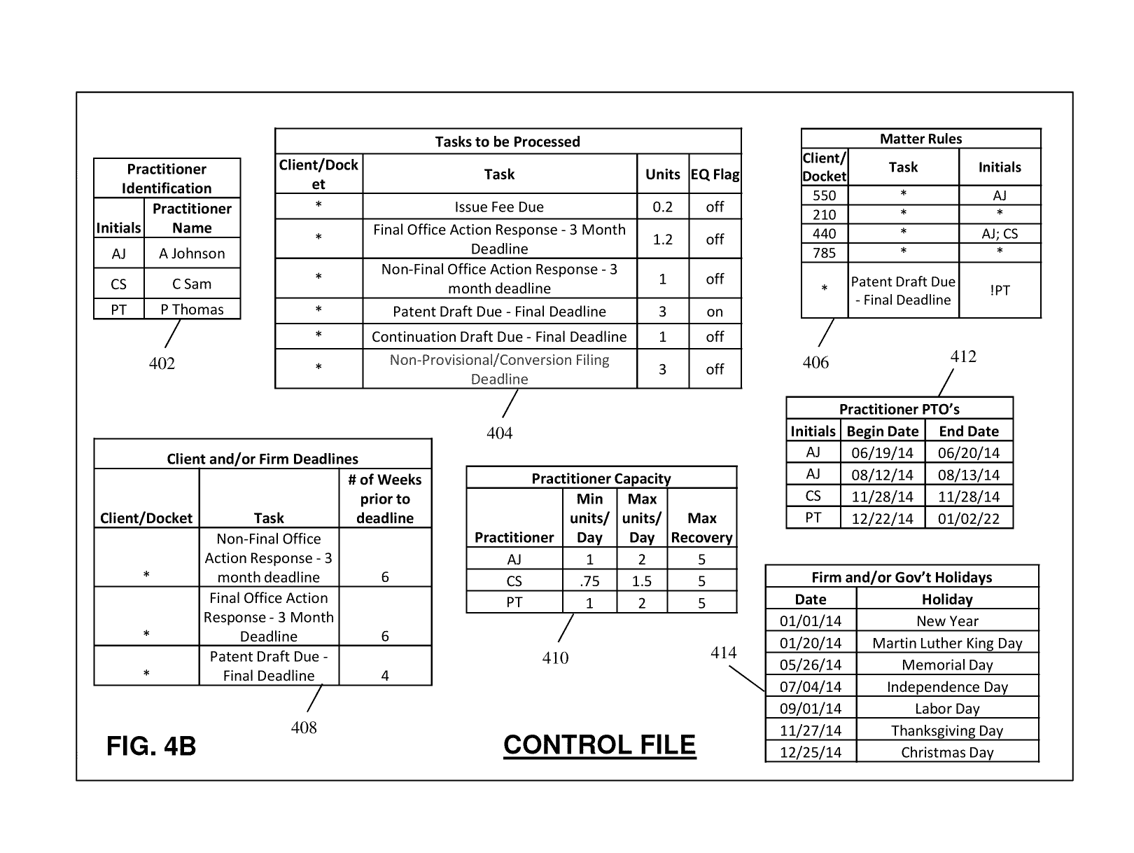

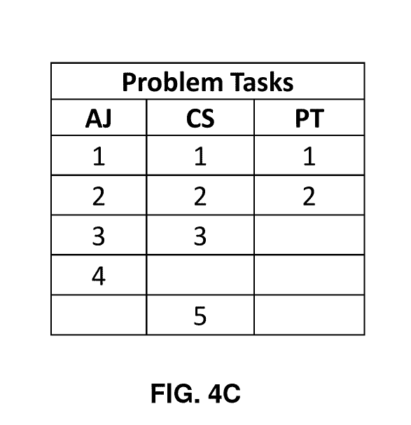

Referring now to FIG. 4A, a task activity can represent, for example, a reminder to prepare a response to a final office action, a restriction election, a non-final office action, or any other activity that may be generated by the docketing system. FIG. 4A presents an illustration of 6 matters assigned to different practitioners identified by their initials (AJ, CS, PT). The Gov't/Client due date of each task is provided by the docketing system according to deadlines set by the patent office (e.g., a 3 month deadline for final and non-final rejections without extensions, etc.), or a client (e.g., 3 month deadline to file a new patent application). The Absolute Due Date can represent a client-based and/or firm-based policy for completing tasks. The Firm Due date can represent a date determined by system 1500 in accordance with the methods of the subject disclosure, which can be the same or sooner than the Absolute Due Date.

Docketing systems can generate an overwhelming number of task activities. Some tasks may be more significant than others as it relates to their revenue potential for the firm. Other tasks may not have any revenue potential and may be used only for administrative purposes, such as notifying clients, reminding inventors to provide feedback when reviewing drafts, and so on. Most docketing systems can generate reports in different formats including Word, Excel, HTML, XML, CSV, tab delimited, and PDF, to mention a few. For illustration purposes, method 100 (and other methods of the subject disclosure) will be described with respect to docketing reports generated in a spreadsheet format.

When office actions and/or client requests for new patent drafts are docketed, such matters generally have a time period of completion which can vary in days, weeks or months. Consequently, a docketing system can be configured to generate a report of all activities for all practitioners over any desirable period extending from the time the report is generated to a future timeframe (e.g., 1 month, 2 months, 3 months, and so on). A comprehensive report of task activities with docket numbers, practitioner initials, and due dates can be used by system 1500 to balance practitioner dockets in according with the methods of the subject disclosure. For illustration purposes only, it will be assumed that a docketing system can be prompted to generate a report (e.g., in a spreadsheet format) having a 3 month timeframe that includes all pending task activities tracked by the docketing system. This report can be used for processing by system 1500 in accordance with the methods of the subject disclosure. This report will sometimes be referred to as a raw Excel file or raw Excel report.

As will be shown, a billing attorney, a term which generally refers to a practitioner responsible for managing one or more client portfolios, can utilize system 1500 and methods executed thereby to manage dockets between practitioners working on matters associated with the one or more client portfolios managed by the billing attorney. In preparation for invoking method 100 by way of system 1500, the billing attorney can provide system 1500 provisioning information by way of a control file such as depicted in FIG. 4B. In one embodiment, the control file can include, among other things, a practitioner identification table 402, a task processing table 404, a matter rules table 406, a client and/or firm deadlines table 408, a practitioner capacity table 410, a practitioner PTO table 412, and a firm and/or government holiday table 414.

The practitioner identification table 402 can comprise an identity of practitioners by the initials (or other identifier) used by the docketing system. As will be discussed shortly, table 402 can be used by system 1500 to identify a first level of parsing of tasks in the raw Excel file using the practitioner initials identified in table 402. The task processing table 404 can identify task activities that are to be processed by system 1500 in accordance with method 100. Each task in table 404 can also include a unit value for normalizing one task relative to other tasks (or a portion of the other tasks). Some clients may have fixed fee arrangements with billing attorneys. In these arrangements, clients can assign fixed fees to office action responses, new patent applications, and other activities, which the billing attorney has agreed to abide by when submitting invoices to the client. To identify a relative unit value between tasks, the billing attorney can identify a “normalized unit value” to distinguish between tasks.

For example, a billing attorney can choose to assign a unit value of 1 unit to final and non-final office actions, which have the same fixed fee. Suppose a new patent application has a fixed fee that is three times that of one of these office actions. Based on this multiple, the billing attorney can assign all new patent application a unit value of 3 units consistent with the fixed fee arrangement. Now suppose restriction election responses are a fourth of the fixed fee of a final or non-final office action. The billing attorney can assign such responses a unit value of 0.25 units. Once the billing attorney normalizes fees by selecting a starting point for unit values (a “normalized unit value”), the billing attorney can then choose the unit value for each task as a multiple of the normalized unit value based on known fixed fees for each task.

This technique can also be used when fixed fee arrangements differ between clients by utilizing the client/docket column of table 404. This column is generally occupied by a docket number for distinguishing matters of different clients. Typically, a base identifier (e.g., 550) is used to identify a client, and the index appended to the identifier identifies a specific matter (e.g., 550-001). In the illustration of FIG. 4B, an asterisk “*” represents a wildcard, which can be used in method 100, to specify that a task and its corresponding unit value are to be applied to all client matters. If, however, the billing attorney wishes to distinguish unit values for tasks of various clients, the billing attorney can specify in the client docket column a base identifier for each client to make such distinctions. For example, the billing attorney can enter another row that shows 550 as the client docket number, the task name, “Issue Fee Due”, and a unit value of 0.4. System 1500 can determine from the two rows associated with the task name, “Issue Fee Due,” that all clients, except the client identified by the base identifier 550, will have a unit value of 0.2 for such tasks, while all matters associated with the client with base identifier 550 will have a unit value of 0.4 for the same task.

The tasks names included in table 404 can be chosen for their corresponding deadlines as a point of reference for scheduling such tasks according to method 100. For example, it is commonly understood that an issue fee arising from a notice of allowance comes due 3 months from the mailing date of the notice of allowance, which is not extendable. Responses for final office actions, and non-final office actions, also come due 3 months from the mailing date of the office action, but can be extended up to a period of an additional 3 months after incurring extension fees. Additionally, different clients request different due dates for patent drafts (e.g., 2-3 months). Consequently, many tasks may have differing due dates that may or may not be extendable. To enable effective processing by system 1500, task names included in table 404 can be chosen by a billing attorney with as much grace period as possible (e.g., deadlines not requiring extension fees) so that system 1500 has flexibility in scheduling and/or assigning tasks in accordance with the methods of the subject disclosure.

The matter rules table 406 can be used to define rules for client matters, tasks, or combinations thereof. It is not uncommon that certain matters can only be worked on by certain practitioners. This may be a client requirement, or simply a result of the matter requiring a skill set that only certain practitioners have. Consequently, there may be instances when practitioners cannot be treated as interchangeable (fungible) on all client matters. Table 406 provides illustrations on how to address matters that may not be fungible. For example, table 406 identifies a single practitioner (AJ) as the only practitioner who can work on client matters identified by base identifier 550. By having a wildcard “*” in the task column, table 406 further indicates that AJ can work on “any” tasks associated with client matters identified by base identifier 550. No other practitioners can work on matters associated with client matters identified by based identifier 550.

In contrast, using the wildcard “*” in the practitioner and task columns for matters having the base identifiers 210 and 785, informs system 1500 that any practitioner can work on “any” tasks relating to matters associated with clients associated with base identifiers 210 and 785, respectively. The third row of table 406 indicates that matters associated with the client identified by base identifier 440 can only be assigned to practitioners AJ and CS, and AJ and CS can work on any asks for such clients. The last row of table 406 indicates that practitioner PT “cannot” be assigned to “any” clients having the task name, “Patent Draft Due—Final Deadline.” The exclamation mark “!” serves as an indicator that PT is authorized to work on such matters. Note that since only PT is identified as not having authority to work on Patent Drafts, AJ and CS do not have this restriction. In one or more embodiments, any form of Boolean logic can be used to formulate rules in the matter rules table 406.

The client and/or firm deadlines table 408 can be used to calculate due dates based on client and/or firm policies. Typically, these dates are more aggressive than the Gov't/Client due dates shown in FIG. 4A. In the illustration of table 408, non-final and final office actions have a client/firm deadline set to 6 weeks prior to the patent office 3 month deadline, while patent drafts have a client/firm deadline set to 4 weeks prior to the deadline set by the client. These tasks are applicable to all clients based on the use of a wildcard “*” in the client/docket column. However, if the billing attorney wished to be client specific, each task can be accompanied with a base identifier (e.g., 550) to identify on a client-basis varying client and/or firm deadlines. Client/firm deadlines represent the “Absolute Due Date” shown in FIG. 4A. In accordance with the methods of the subject disclosure, system 1500 will attempt to identify Firm Due Dates that are more aggressive and no less than the Absolute Due Date calculated in accordance with table 406.

The practitioner capacity table 410 depicts the capacity of each practitioner on a daily basis. It will be appreciated that other ratios are possible (e.g., weekly capacity, monthly capacity, etc.). The minimum and max unit columns identify a range of units that a practitioner can be assigned. The minimum units column indicates in the case of AJ that at least 1 unit should be assigned each “available” business day to AJ, and no more than 2 units in a single business day. The maximum recovery column indicates that if 2 units are assigned to AJ on any particular day, system 1500 should wait at least 5 business days before assigning once again 2 units in a single day. This metric can be helpful to avoid consecutive use of max units, which may overload a practitioner. It is further noted that fractional units are possible as depicted for CS. When fractional units are used, units can be translated into days or working hours to determine how to distribute matters. For example, in the case of a 1 unit task, CS would require 1 and ⅓ days (i.e., 1 divided by 0.75) to complete the task. Matters totaling 2 units would require 2 and ⅔ days for CS to complete, and so on. As will be shown later, the practitioner capacity table 410 will be used by system 1500 to determine how to distribute matters between practitioners.

The practitioner PTO table 412 can be used to identify paid time off (PTO) periods, which can represent vacation time, sick leave, family leave, etc. Similarly, the firm and/or government holiday table 414 can be used to identify holiday periods. Tables 412 and 414 can be used to remove or block business days from practitioner calendars prior to assigning tasks to them.

The provisioning information of FIG. 4B can be used by system 1500, in accordance with method 100 (and other methods of the subject disclosure), to assign tasks between practitioners in a balanced manner, and to select a Firm Due date that is better or the same as the Absolute Due Date as depicted in FIG. 4A. With this in mind, system 1500 can begin execution of method 100 at step 101. The step 101 represents a combination of steps to initialize tasks in preparation for balancing tasks between practitioners. At step 102, system 1500 can use the information in tables 402 and 404 to parse tasks in the raw Excel file, and thereby identify tasks to be processed and those to be moved to an unused tab of the Excel file. For example, table 402 can be used to identify tasks associated with the initials of practitioners listed in table 402. Tasks associated with initials of other practitioners are moved to the unused tab of the spreadsheet. Table 404 can be further used to identify tasks of interest, and to move all other tasks to the unused tab. The combined parsing of tasks in the raw Excel file based on tables 402 and 404, enables system 1500 to produce a net task list for processing. At step 102, system 1500 can further add unit values listed in table 404 to all tasks in the net task list. At step 104, system 1500 can apply PTO's and firm/gov't holidays to all calendars of practitioners to assure that tasks are not assigned during those times. At step 106, system 1500 can calculate Absolute Due Dates based on the client and/or firm deadlines of table 408. The Absolute Due Dates can be inserted in the column shown in FIG. 4A for the tasks that remain to be processed.

Step 107 represents a combination of steps for identifying and processing “stragglers” and “reusable tasks.” Based on prior iterations of method 100 by system 1500, tasks are scheduled and balanced between practitioners. Subsequent iterations of method 100 by system 1500 can result in the identification of “stragglers” and “reusable tasks.” Stragglers can represent tasks that have a past due Firm Due Date, tasks that violate an Absolute Due Date (which may be due to a change in client or firm policies), or tasks that overlap with new PTO requests that were not addressed by system 1500 on a prior iteration of method 100. For example, suppose a task was assigned a Firm Due Date by system 1500 on a prior iteration of method 100. Further, suppose the practitioner assigned to the task by system 1500 has been unable to complete the task on the given Firm Due Date. Further assume that the Absolute Due Date and the Gov't/Client Due Date have not expired. Then this task would be considered a straggler that needs rescheduling. Reusable tasks can represent tasks previously given a Firm Due Date by system 1500 that have not expired. Such tasks can be treated by system 1500 as reusable candidates that under certain circumstances can be retained with the same Firm Due Date.

With this in mind, system 1500 can identify at step 108 reusable tasks having a Firm Due Date that has not expired. At step 110, system 1500 can identify stragglers based on expired Firm Due Dates, violations of Absolute Due Dates, or PTO overlaps as previously described. At step 112, system 1500 can identify tasks that violate a rule defined in the matter rules table 406, such as, for example, a violation due to a reassignment of a matter or some other rule violation. In this step, system 1500 can attempt to reassign the task to another practitioner. If the task cannot be reassigned to any practitioner, then the task is placed in a “problem bucket.” Tasks may not be assignable to another practitioner if the practitioner, for example, does not have available time on his/her calendar due to the reusable tasks, or because assigning the task would cause a max units violation according to table 410. If this happens, system 1500 transitions to the next practitioner to determine if the task can be reassigned. This process continues until all practitioners have been exhausted. If the task cannot be assigned to any of the practitioners, then it is placed in the problem bucket.

At step 114, system 1500 can attempt to fix straggler tasks identified at step 110 by fitting the straggler in an available time slot of the practitioner that was originally assigned to the task. This may require rearranging the reusable tasks by changing the Firm Due Dates of the reusable tasks. Typically, stragglers that are past due will likely require an earlier draft date than most reusable tasks. Depending on the unit value of the straggler, it may require pushing the reusable tasks further out in time to fit the straggler. For example, a 1 unit straggler for AJ will require a full business day to fit into Al's schedule. If reusable tasks can be pushed out by a day without violating the Absolute Due Date, then system 1500 will make such adjustments at step 114 to the Firm Due Dates of the reusable tasks to fit the straggler.

If system 1500 cannot push out the reusable tasks, then it will analyze at step 116 the Absolute Due Dates of the reusable tasks to determine how they may be rescheduled to make room for the straggler. In the same step, system 1500 can also determine if a max units limit can be applied to one or more of the reusable tasks without violating the max recovery time rule. For example, system 1500 can determine whether applying 2 units in a single business day for any existing reusable task of AJ can make room for a straggler of 1 unit. If this is possible, then system 1500 will change the Firm Due Date of the straggler to match that of another task, thereby maintaining the straggler with AJ. If neither of these attempts works, then system 1500 can proceed to step 118 where it places the straggler in the problem bucket. Steps 114-118 are repeated until all stragglers have been processed.

At step 122, system 1500 can make another attempt to address tasks in the problem bucket (i.e., tasks that could not be reassigned at step 112 and/or stragglers that were not assignable) by assessing whether any of the problem tasks can be assigned between practitioners. In this step, system 1500 can create a matrix that maps each problem task to possible placements between practitioners in accordance with the rules set out in the control file. FIG. 4C provides an illustration of such a mapping. In this illustration there are 5 tasks in the problem bucket. In one embodiment, the matrix of FIG. 4C is constructed on the basis of any “single” one of the problem tasks being assignable to AJ, CS or PT by locating available time slots, adjusting Firm Due Dates of reusable tasks, by applying the max unit of a practitioner one or more times, and by complying with other rules defined in the control file of FIG. 4B. The matrix of FIG. 4C does not, however, guarantee that combinations of problem tasks can be assigned to the same practitioner. That is, although AJ can be assigned tasks 1, 2, 3, or 4, the matrix of FIG. 4C does not guarantee that combinations of these tasks are assignable.

To increase the likelihood of multiple assignments, system 1500 can be adapted to assign the tasks with the fewest assignable options first. For example, system 1500 can begin by assigning task 4 to AJ and task 5 to CS. System 1500 can then determine if task 3 remains assignable to AJ or CS. If task 3 can be assigned to AJ or CS, system 1500 can, for example, choose whichever practitioner has the lowest total unit count. System 1500 can then proceed to assign task 2 to any of the practitioners that can accept this task. If more than one practitioner can be assigned task 2, then once again system 1500 can choose the practitioner with the lowest total unit count. The same logic can be applied to task 1. If any of the tasks in the problem bucket cannot be readily assigned by shifting Firm Due Dates of reusable tasks, or applying the max units of a practitioner, then such a task can be placed once again in the problem bucket.

It will be appreciate that more aggressive algorithms can be used at step 122. For example, system 1500 can be adapted to construct a comprehensive matrix of all possible combinations of problem tasks that can be assigned to any one practitioner, and thereby identify from all the possible combinations a solution that increases the likelihood of assigning practitioners all or a substantial portion of problem tasks in the problem bucket.

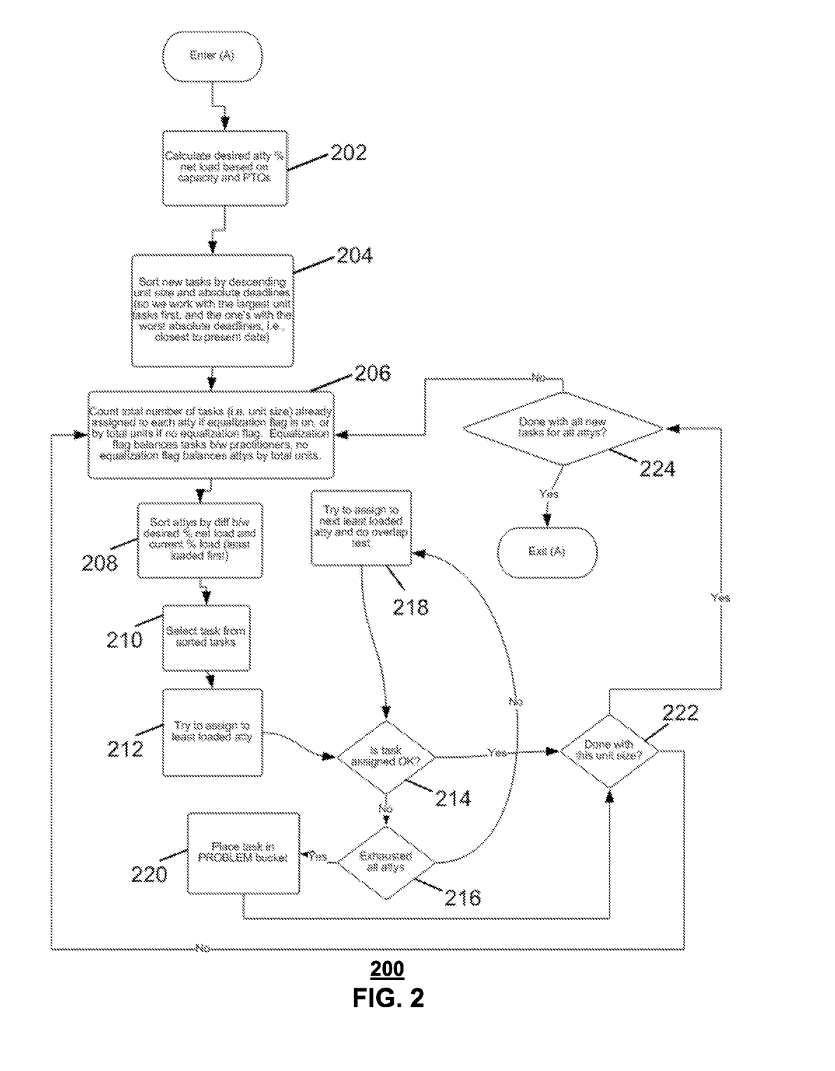

Once step 107 has been completed, system 1500 can proceed to step 124 to process new tasks. New tasks can be identified as tasks that have not been assigned a Firm Due Date. Such tasks are typically new office actions, new patent application requests, new trademark requests, and other related activities that have been docketed and have not been assigned a Firm Due Date. Thus, any task identified in the raw Excel file generated by the docketing system with a blank Firm Due Date can be considered a new task. Such new tasks can be processed by system 1500 in accordance with method 200 of FIG. 2. System 1500 can begin with calculating at step 202 a net capacity of each practitioner based on the practitioner capacity table 410 and the practitioner PTO table 412.

In one embodiment, the net capacity of each practitioner can be determined according to the following steps:
1. Sum min unit of all practitioners (total practitioner units)
2. Calculate a gross capacity for each practitioner according to [(min unit of a practitioner)/(total practitioner units)]*100%
3. Calculate total units of “all” tasks to be processed based on the results of step 102 of FIG. 1 (total task units)
4. Calculate a balanced distribution of units for each practitioner (ideal units): gross capacity of practitioner*total task units
5. Determine PTO time for each practitioner from PTO table, and translate PTO time into units (PTO units): PTO time*min units/day of each practitioner
6. Adjust the ideal units of the affected practitioner, and distribute the PTO units evenly to remaining practitioners (adjusted units)
7. Apply steps (5)-(6) across all practitioners
8. Once completed, determine net capacity according to adjusted units of each practitioner

With the above method, we begin at step (1), the total practitioner units is 2.75 (1+0.75+1) based on the illustration of table 410.

At step (2), the gross capacity for AJ and PT is −36.4% (1/2.75*100%), while the gross capacity for CS is −27.2% (0.75/2.75*100%).

At step (3), suppose that total units of “all” tasks remaining after step 102 of FIG. 1 is 200 units.

At step (4), the ideal units to assign to each practitioner would be 73 units for AJ (36.4%*200 units), 73 units for PT (36.4%*200 units), and 54 units for CS (27.2%*200 units).

At step (5), suppose that AJ has 5 PTO days, while PT and CS are not requesting PTO days. For AJ, 5 PTO days, represents 5 units of work (5 days*1 unit/day). This represents 5 units of work that cannot be assigned to AJ.

At step (6), the ideal units of AJ are reduced by 5 units, resulting in a new total of 68 units. The PTO units are divided between CS and PT, thereby raising CS's ideal units to 76, and PT's ideal units to 56

At step (7), since AJ is the only practitioner with PTO time, there is no need to perform more iterations of steps (5)-(6)

At step (8), the net capacity of AJ is now 34% ( 68/200*100%), the net capacity of CS is 38% ( 76/200*100%), and the net capacity of PT is 28% ( 56/200*100%)

Once the net capacity of each practitioner has been determined at step 202, system 1500 can proceed to step 204 where it sorts new tasks by descending unit size and Absolute Due Dates. For example, patent drafts and provisional conversions in table 404 have a unit size of 3 units, while non-final and final office actions have a unit size of 1 unit each. At step 204, patent drafts and provisional conversions would be at the top of the sorted tasks followed by non-final and final office actions. These tasks would also be sorted by the Absolute Due Dates so that tasks with a higher urgency for completion are at the top of the stack, and are assigned first by system 1500.

At step 206, system 1500 can count per practitioner the number of tasks of the same unit size already assigned to the practitioner if an equalization flag is on (see EQ flag column of table 404), or according to total units presently assigned if the equalization flag is not on. This step enables system 1500 to balance the distribution of new tasks by unit size or by total units. For example, suppose the equalization flag is on for patent drafts as shown in table 404. System 1500 would then count the number of patent drafts of the same unit size that have been assigned to each practitioner prior to distributing new patent draft tasks.

For example, suppose AJ has 1 patent draft task, CS has 2, and PT has 2—a total of 5 patent draft tasks. Further, suppose that there are 6 new patent draft tasks to be distributed. With the equalization flag on, system 1500 will attempt to distribute the new patent draft tasks in a balanced manner so that the net unit count between patent drafts of each practitioner conforms as close as possible to the net capacity of each practitioner. The current net load of AJ in relation to patent draft tasks already assigned is 20% (⅕*100%), while CS and PT have a current net load of 40% (⅖*100%). At step 208, system 1500 can sort AJ, CS and PT by comparing their current net capacity to their ideal net capacity calculated at step (8) above. This places AJ first, followed by CS and PT. System 1500 selects at step 210 a task at the top of the sorted tasks and then attempts to assign the task at step 212 to AJ. If the assignment is successful at step 214, system 1500 proceeds to step 222 to determine if the tasks of a given unit size have all been assigned. If not, system 1500 proceeds to step 206 and recalculates the current net load of all practitioners based on the new assignment.

Thus, if a new patent draft task was successfully assigned to AJ, AJ would now have a current net load of 33.3% ( 2/6*100%), the same as CS and PT. At step 208, AJ would drop below CS since CS has an ideal net capacity of 38%, which is higher than AJ at 34%. Steps 210-212 would then apply to CS, and if a new patent draft task is successfully assigned to CS, the current net load would be recalculated at step 206. This process repeats until the 6 patent draft tasks have been distributed between AJ, CS and PT. Note that not all patent draft tasks may be assignable evenly between practitioners if one or more of the tasks has been pre-assigned or violates a rule in the matters rule table 406. Accordingly, even if the equalization flag is on, there is no guarantee that the new tasks of a certain unit size will be distributed according to the net capacity figures calculated at step (8) above. It is further noted that if new tasks cannot be assigned at step 212, such tasks would be placed by system 1500 in the problem bucket at step 220 if system 1500 detects at step 216 that attempts have been made with all practitioners to assign the task, thereby exhausting all possibilities. However, if system 1500 has identified a task it cannot assign, but there are other remaining practitioners, then system 1500 proceeds to step 218 to determine if another practitioner can be assigned the task.

Referring back to step 206, if the equalization flag had not been set to on for patent drafts, then system 1500 determines the current net load of each practitioner by summing the total units of tasks that have already been assigned, and determining a current net load from these figures. For example, suppose the current total unit count for AJ and PT is 70 units, and 25 units for CS. Note the total unit count between AJ, CS and PT in this illustration is less than the total unit count of all tasks, because the total unit count of each practitioner is representative of the unit count of reusable tasks, not new unassigned tasks. With this in mind, the current net load of AJ and PT, respectively, would thus be 42%, while the current net load for CS would be 15%. According to steps 208-212, all of the new patent draft tasks would be assigned to CS assuming no rules are violated since an additional 15 units (i.e., 5 patent drafts*3 units each) would not raise CS's total unit count sufficiently to drop CS below the top sorting position at step 208. This, however, may not always be an effective way to distribute large unit size tasks between practitioners, as it may overload certain practitioners. Thus, the equalization flag enables billing attorneys to distribute tasks of large unit sizes more evenly.

Once system 1500 detects at step 222 that all tasks of a particular unit size have been processed, system 1500 proceeds to step 224 to determine if all new tasks have been processed. If new tasks remain to be assigned, then system 1500 proceeds to step 206 and repeats the process previously described. If all new tasks have been processed, system 1500 proceeds to step 125 of FIG. 1. At this stage, system 1500 performs at step 126 an additional attempt to assign tasks in the problem bucket by swapping where possible tasks between practitioners to make room for the problem tasks. At step 128, system 1500 compresses unused time between tasks by updating the Firm Due Date of each task. The Firm Due Date assigned at this step tends to be more aggressive than the Absolute Due Date calculated at step 106, which is a desirable result since a goal of method 100 is to occupy as many business days with tasks as possible to increase the firm's revenue potential by preventing over and under allocation of tasks, improve the timeliness of task completions, and improve the firm's fee collections, among other benefits.

At step 130, system 1500 can compare the balance of units between practitioners to a tolerance threshold. Recalling the net capacities of AJ (33.5%), CS (37.5%), and PT (29%) determined at step (8), system 1500 can compare these figures to actual figures after completing steps 101-124. For example, suppose the total unit count for AJ and CS is 60, and for PT is 80. This presents a current net load for AJ at 30%, CS at 30%, and PT at 40%. Now suppose the tolerance threshold is set to 25% of the ideal net capacity of each practitioner. When comparing the current net capacity figures to the ideal net capacity of each practitioner, system 1500 can determine at step 132 that the distribution of units between practitioners is within the tolerance threshold and rebalancing is not necessary. If, however, rebalancing is necessary, system 1500 can attempt a rebalancing by reassigning between practitioners tasks having the latest Absolute Due Dates. If this fails, method 100 can be adapted to cease further attempts after it reaches a threshold of failed attempts.

Methods 100 and/or 200 can generate an updated Excel spreadsheet with resorted tasks, assignments, and Firm Due Dates. The updates can be highlighted in color to show the billing attorney how the tasks have been processed. For example, if a task was previously assigned to a practitioner and now is assigned to a different practitioner, the initials of the new practitioner can be highlighted in color or other indicia to show a new assignment. Similarly, Firm Due Dates that have been updated for reusable tasks, and/or Firm Due Dates that have been assigned to new tasks can be highlighted in color. Any tasks that could not be assigned to a practitioner can be placed in a problem tab of the spreadsheet for review by billing attorney to determine how best to address them.

While for purposes of simplicity of explanation, the respective processes are shown and described as a series of blocks in FIGS. 1-2, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

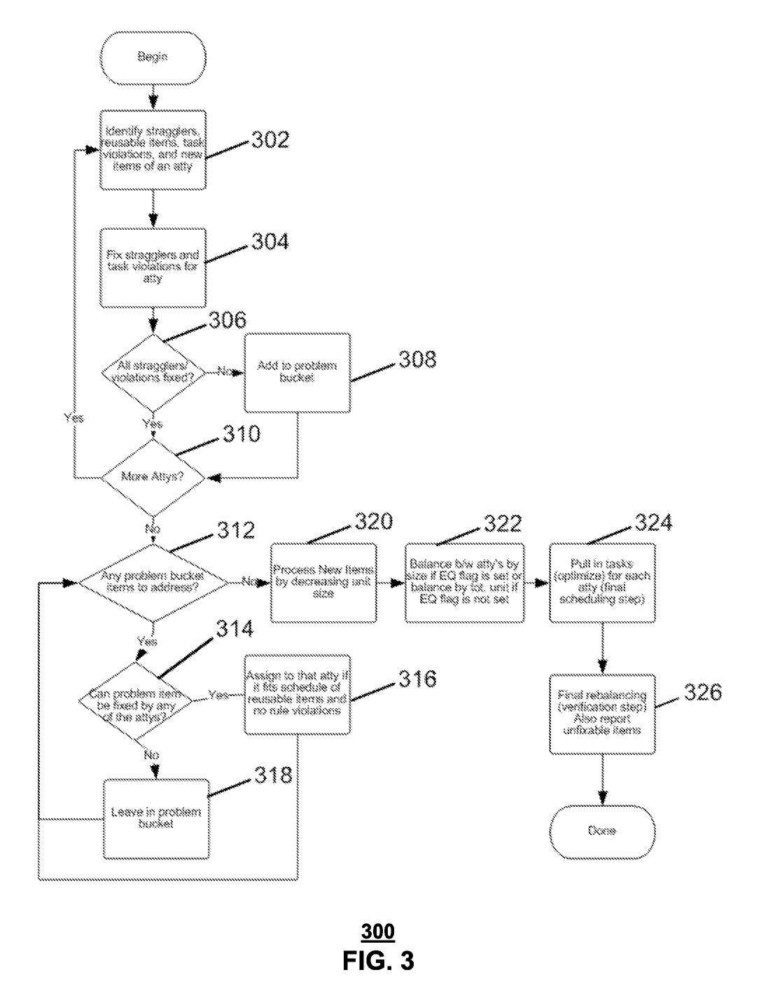

It is further noted that the processes of FIGS. 1-2 can be modified in other ways without departing from the scope of the claimed subject matter. For example, FIG. 3 depicts a method 300 for processing tasks supplied by a docketing system. Method 300 can make use of some or all metrics included in the control file of FIG. 4B. Method 300 can begin at step 302 where system 1500 identifies stragglers, reusable tasks, task violations, and new tasks in ways that may be similar to what has been previously described. At step 304, system 1500 can attempt to fix stragglers and task violations by, for example, updating Firm Due Dates of reusable tasks, applying max units to certain reusable tasks, and/or by making use of available time slots in a practitioner's calendar. If all stragglers and task violations have not been assigned at step 306, the problem tasks can be placed by system 1500 in a problem bucket at step 308, and system 1500 can proceed to step 310 to determine if more practitioners require processing. If so, system 1500 repeats these steps until all practitioners have been processed.

Once all practitioners have been processed, system 1500 can proceed to step 312 to determine if any tasks are present in the problem bucket. If so, system 1500 can proceed to step 314 to determine if the problem tasks can be assigned to other practitioners in accordance with the rules established in the control file. If they can, then such tasks are assigned to the practitioner(s) identified at step 316; otherwise, system 1500 maintains the unassignable tasks in the problem bucket at step 318. Once all problem tasks have been addressed, system 1500 can proceed to step 320 to process new task items by decreasing unit size. At step 322, system 1500 can balance the distribution of new tasks according to its unit size if the equalization flag is set, or according to total unit counts of each practitioner if the equalization flag is not set. At step 324, system 1500 can compress the calendar placement of tasks by updating Firm Due Dates to make use of available business days, thereby pulling in tasks to earlier dates. At step 326, system 1500 can perform final rebalancing if the current unit loads differ beyond an acceptable tolerance threshold from the ideal net capacity loads of the practitioners. In this step, system 1500 can also report problem tasks that were not successfully assigned.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

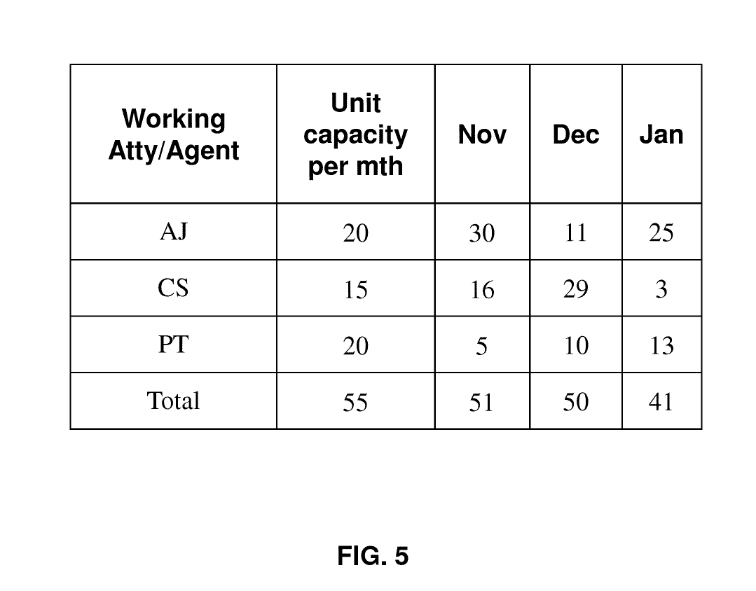

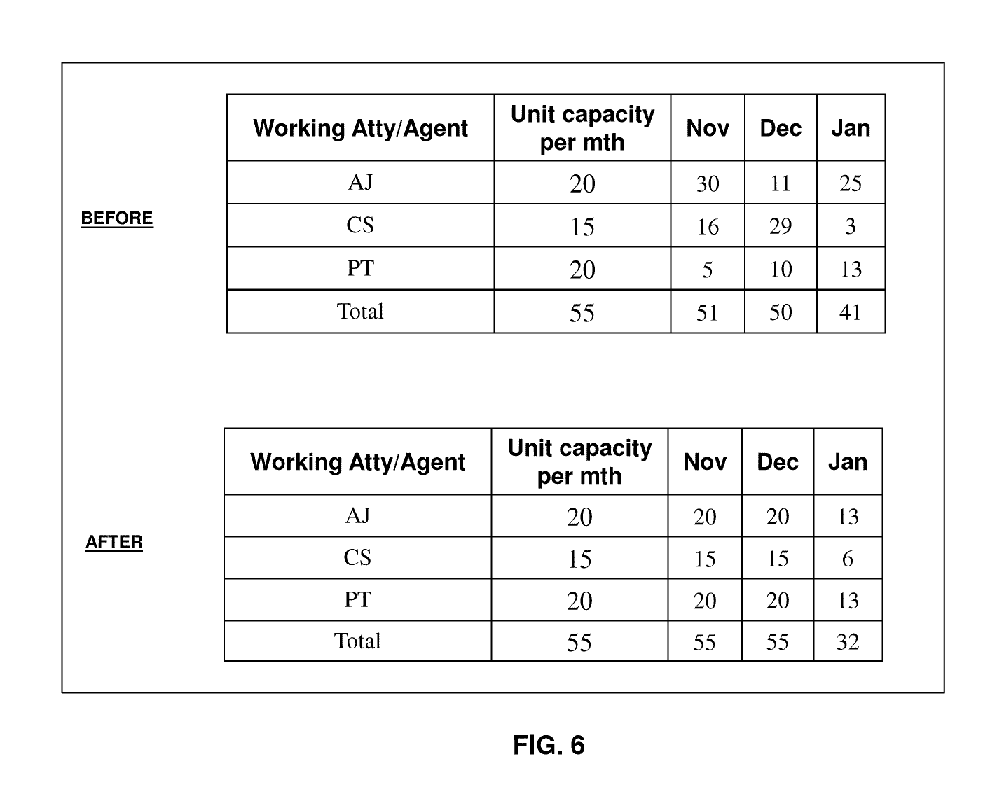

The benefits of using methods 100-200 or method 300 can be depicted by the illustrations of FIGS. 5-6. FIG. 5 depicts an illustration of a unit breakdown between AJ, CS, and PT based on unprocessed task data supplied by a docketing system. The unit capacity of each practitioner in FIG. 5 is presented on the basis of an assumption that there are on average 20 business days per month. In this illustration, it is further assumed that no PTO's have been requested by the practitioners. It is evident from FIG. 5 that AJ, CS and PT have an imbalanced distribution of units between them, and are also imbalanced when comparing current unit assignments with their respective unit capacities per month. In most instances, it is expected that methods 100-200 or method 300 can process the tasks provided by the docketing system and produce a balanced redistribution that may look something like the before and after comparisons of FIG. 6.

As noted earlier, a balanced distribution of units between practitioners can have many benefits, among them, reducing the likelihood of over allocated and under allocated dockets, improving practitioner efficiencies, improving revenue collections, increasing subject matter expertise, and reducing unbillable time spent on unproductive scheduling techniques. These improvements can also result in better client relations and a greater likelihood of repeat business, as well as, new matter intake from such clients, which is highly desirable in a service-oriented environment such as with law firms specializing in intellectual property matters.

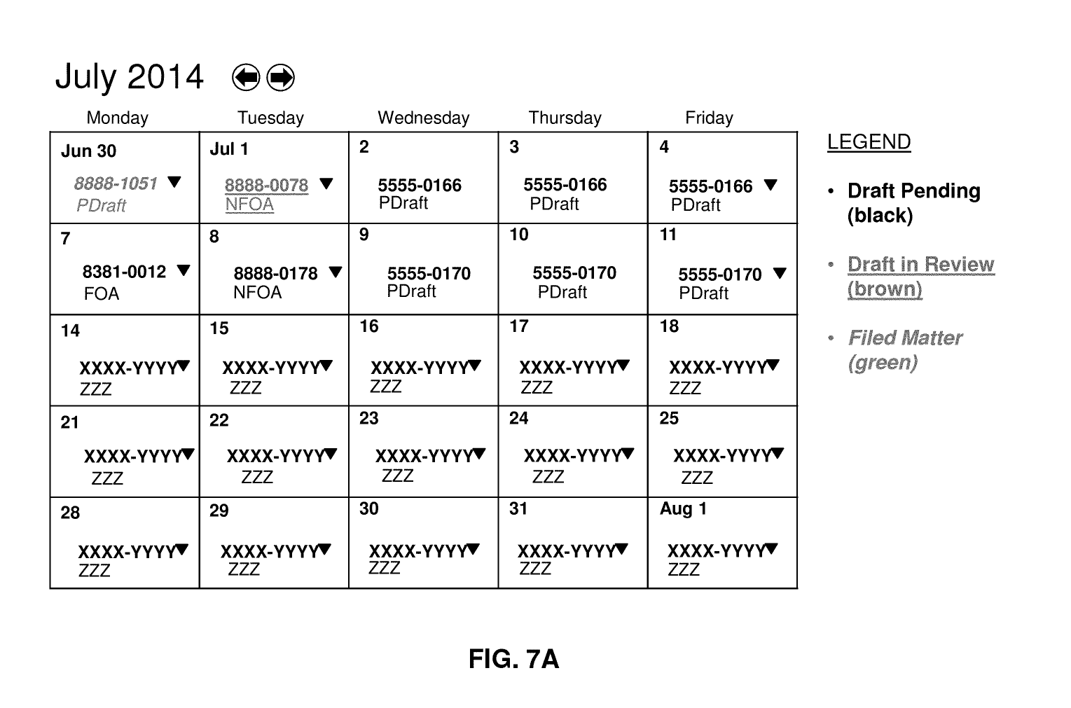

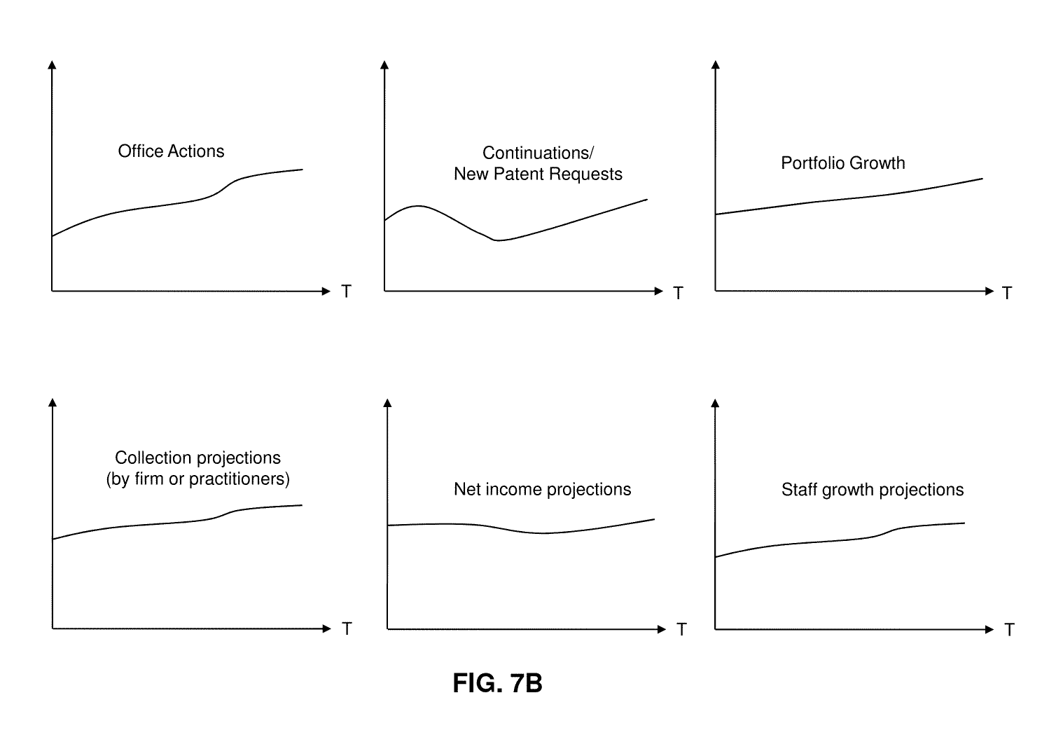

The embodiments of methods 100-300 of FIGS. 1-3 can also be adapted to present the results of processed tasks in a graphical user interface such as the calendar format shown in FIG. 7A. In this illustration, task assignments can be depicted for each practitioner in a calendar format. In one embodiment, each practitioner sees only their respective assignments. A billing attorney, on the other hand, can see an aggregate assignment of all matters on his or her calendar. Practitioners can scroll between calendar months at ease by selecting the right or left arrows with a mouse button. Additionally, practitioners can be provided a drop-down menu depicted by an upside-down triangle to change the status of a pending draft to a “Draft in Review” or a “Filed Matter.” The change in status can be illustrated in color (black, brown or green) according to the Legend. Alternatively, or in combination, the font type of the tasks can be changed to depict a status change.

Additionally, methods 100-300 of FIGS. 1-3 can be adapted so that system 1500 can request task reports from the docketing system by way of an applications programming interface (API) or web services interface of the docketing system, and thereby perform task processing on a periodic basis. System 1500 can also be adapted to submit the results of the processed tasks to the docketing system via the API or web services interface to update Firm Due Dates and new practitioner assignments, which can in turn result in an update of the calendar GUI of each practitioner and the billing attorney. In yet another embodiment, practitioners can attempt by way of the calendar GUI to move tasks to different dates. This action can result in system 1500 performing an analysis of the requested transaction and determining whether such a request can be approved or denied due to a rule violation. If approved, system 1500 can also adapt other tasks to accommodate the request. System 1500 can then update the docketing system via its API or web services interface as previously described with the changes made.

Methods 100-300 can also be adapted to receive data from a billing system such as fee collections data, accounts receivable data, time entries by attorneys, expenses, net income information, balance sheet information, and so on. Methods 100-300 can be adapted to identify unit trends (per month, quarter or otherwise), and predict an uptake or downturn in business using regression analysis or other techniques. Methods 100-300 can be adapted to retrieve from the docketing system and identify trends from incoming office actions and new matters (such as continuations and new patent draft requests) versus requests by clients not to pursue continuations or foreign prosecution. These trends can collectively be used to predict future revenue, expected net income based on expense trends determined from the information provided by the billing system, and so on. Such predictions can also be used by firm managers to predict when it may be appropriate to hire new staff (e.g., paralegals, attorneys, agents, administrative staff, etc.). Such trend figures can also be used to predict collections for each practitioner. Such trends can be used to determine a practitioners' performance at any given point in time, and can also be used to predict practitioner bonuses. Such predictions can be shared with practitioners via reports that can be displayed graphically on their computer terminals to motivate them to maintain their performance or to improve their performance as the case may be. FIG. 7B depicts illustrations of the aforementioned trend reports.

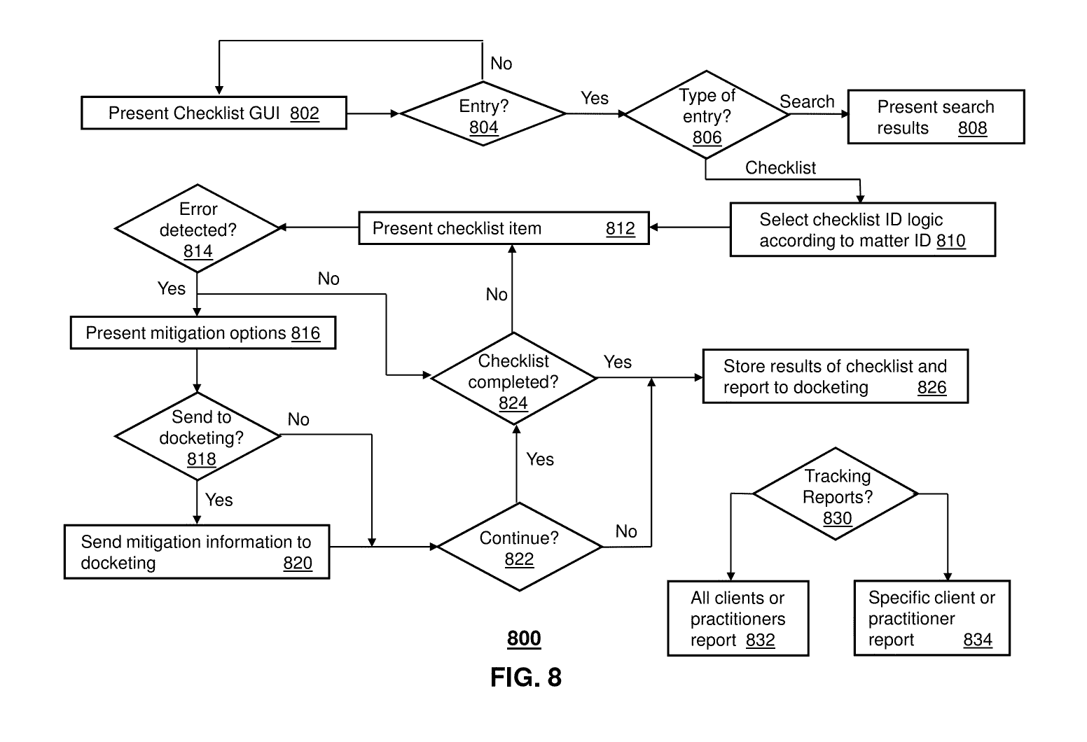

FIG. 8 depicts exemplary, non-limiting embodiments of a method 800 for processing checklists. Method 800 can be performed by system 1500. A checklist can be an integral tool of a docketing system or can be implemented separately. Checklists can be used to memorialize best practices of an enterprise such as a law firm. Checklists can be used to reduce human error, and thereby improve the quality of the work product of each practitioner. Combining the methods of the subject disclosure for balancing practitioner dockets and maintaining a consistent level of work product quality by using checklists can provide a firm a valuable competitive edge that is recognizable and rewarded by clients.

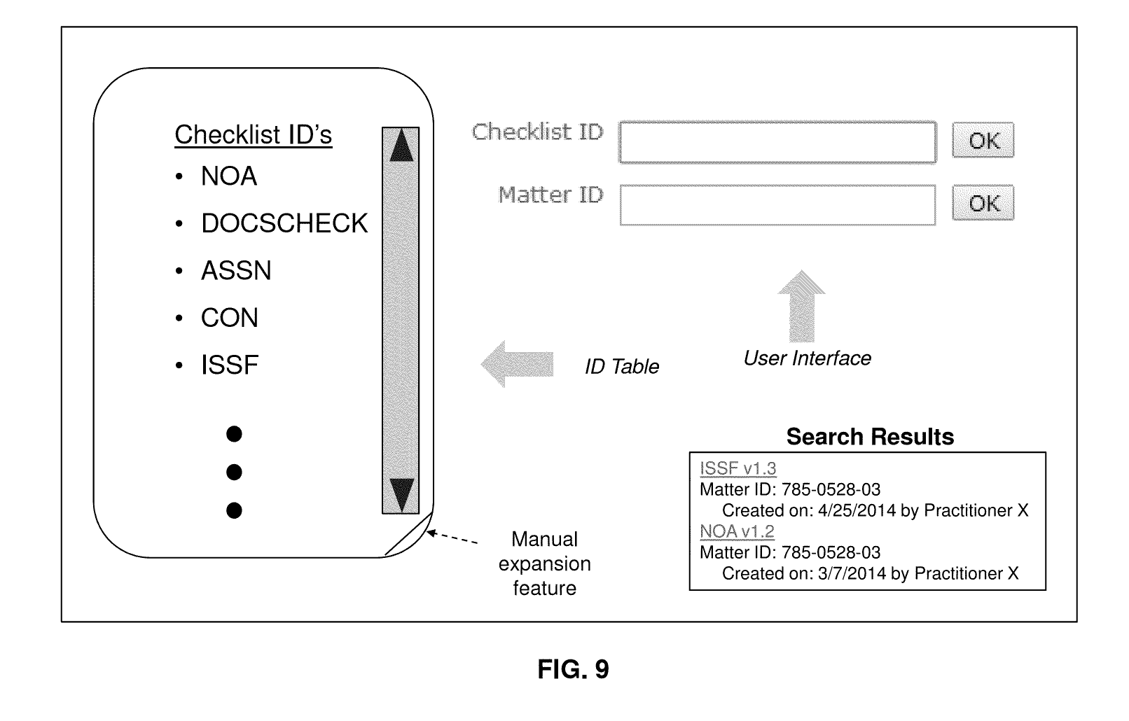

Method 800 can begin with step 802 where system 1500 presents a graphical user interface (GUI) for checklists as depicted in FIG. 9. A checklist GUI can comprise a selectable list of checklist ID's, which can be scrolled and resized. Each checklist ID can represent a sequence of checklist items for reviewing documents or related activities. For example, the checklist ID “NOA” can represent a checklist for reviewing Notices of Allowances. The checklist ID “ASSN” can represent a checklist for reviewing a recordation of intellectual property assignments. A checklist of any type can be created, such as by firm management, pursuant to the subject disclosure.

Checklists are generally constructed from the accumulation of years of experience by practitioners in identifying common human errors that occur during prosecuting matters. Checklists can serve as valuable tools that can help practitioners reduce error by removing the burden of practitioners having to remember best practices of their firm. In the GUI of FIG. 8, a checklist ID can be manually entered in the checklist ID field or can be invoked by selecting an ID from the ID table. Practitioners can also enter a matter ID (such as the docket numbers shown in FIG. 4A) to retrieve a history of prior checklists that have been submitted for a particular matter.

At step 804, system 1500 can be configured to monitor whether an entry has been made by a practitioner. If an entry is detected, system 1500 proceeds to step 806 to determine if the entry involves a request for a checklist or a request to search a history of prior checklist submissions. If it is the latter, system 1500 proceeds to step 808 to present search results such as those shown in FIG. 9. In this illustration practitioner X (e.g., AJ) has submitted two checklists for matter ID 785-0528-03. The checklists include an NOA checklist (for reviewing notices of allowances), and an ISSF checklist (for reviewing issue fee payments). The date when the checklists were created is noted in the search report. Additionally, the version number of the checklist ID is identified in the report. Knowing the version of a checklist ID that was used at the time of the submission may be useful information to the practitioner requesting the report. As will be described shortly, user-generated responses of a checklist can be stored in a searchable database (e.g., a SQL database) used by system 1500.

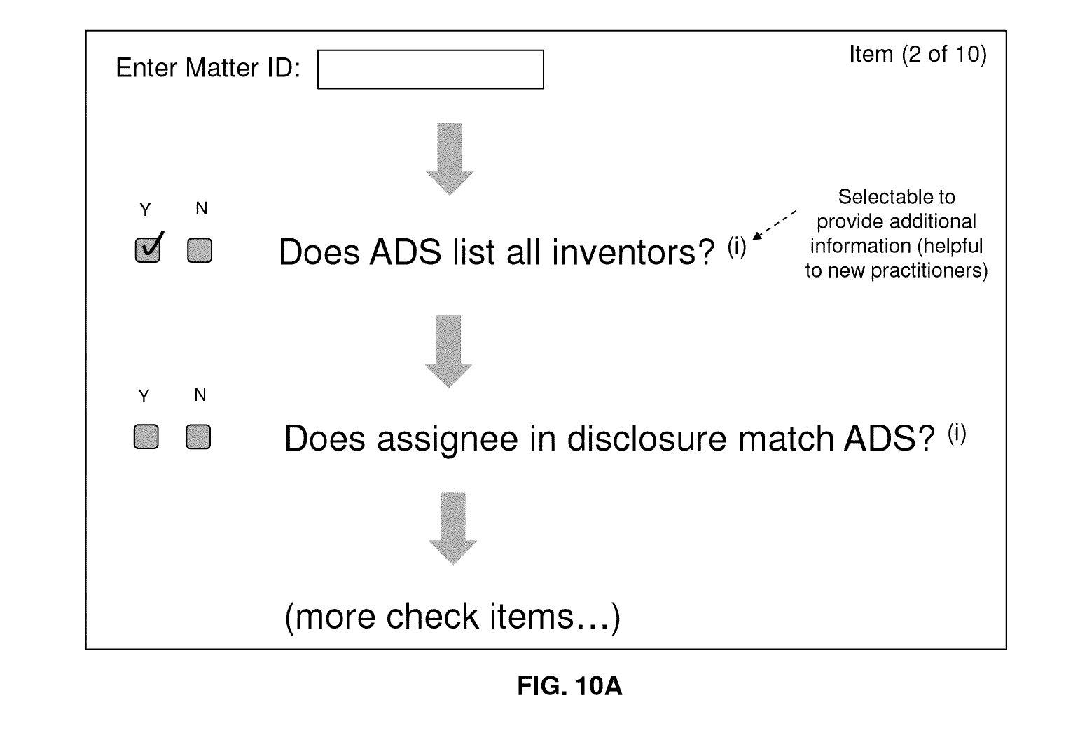

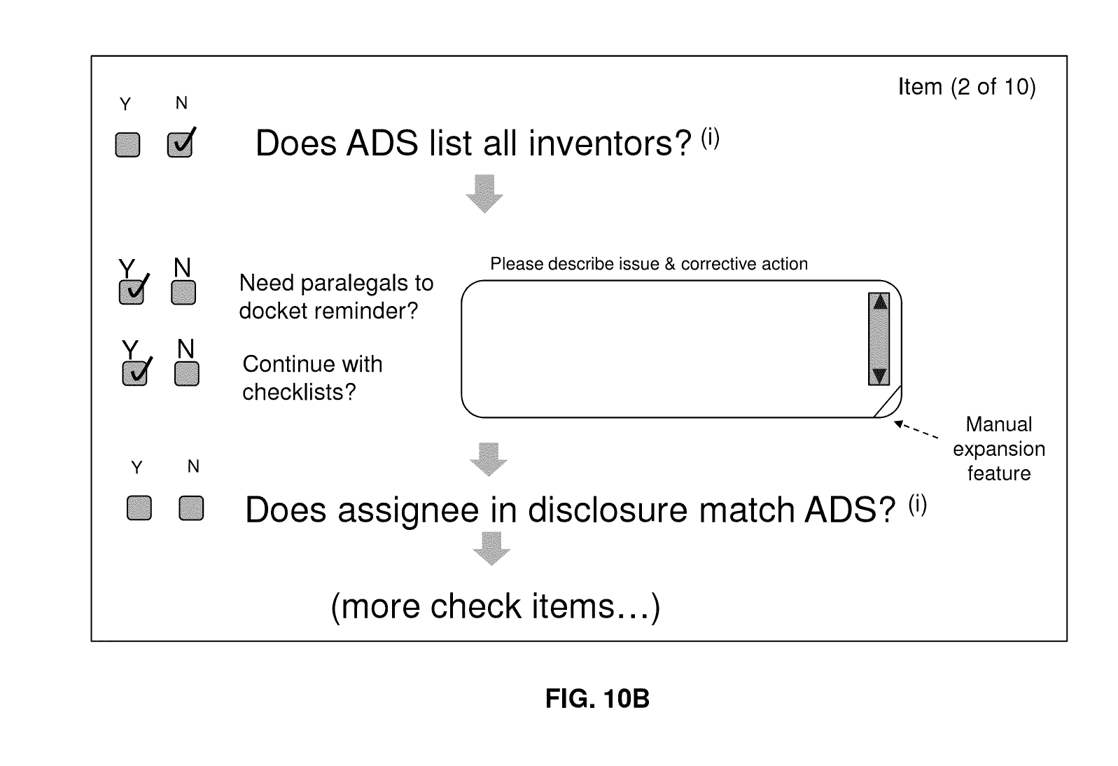

Referring back to step 806, if the entry is a checklist request, system 1500 can proceed to step 810 to select a checklist logic sequence that matches the checklist ID provided in FIG. 9 and the matter ID entered by the practitioner in the field shown in FIG. 10A. As noted earlier, a matter ID can be a docket number for identifying a specific matter. The base identifier (e.g., 550) can be used to identify the client associated with the matter. Matching checklist logic sequences to a client base identifier and checklist ID enables firm managers to construct checklist logic that is client specific.

This approach is in stark contrast to practitioners who generalize checklist by utilizing the same checklist items for all clients. A generalized checklist can make the checklist process ineffective. For instance, suppose a practitioner enters the Checklist ID “ASSN.” Reviewing assignee names can be an important checklist item when reviewing assignments. It is very important that the assignee listed in an assignment agreement is properly spelled, has a proper state of incorporation, and address. When the same checklist is used for reviewing assignments of multiple clients (e.g., 15 different clients), the checklist becomes unwieldy and wordy. A generalized checklist in this example would require a listing of 15 different assignee names, incorporation information, and addresses. This could make the checklist very long and could easily distract a practitioner from important details during the review process.

To overcome this limitation, system 1500 can be configured to retrieve a checklist logic sequence that is client specific. Utilizing the base identifier of the client also has the added benefit of enabling firms to use the same Checklist ID for all clients. For example, the checklist ID ASSN can be used for all clients. However, the client base identifier (e.g., 550) identifies a specific checklist logic sequence that may be different from other clients. Accordingly, the checklist ID ASSN can have many logical variants, each being client specific. Thus under method 800, when a checklist item for reviewing an assignee arises, the information listed in the checklist item is specific to the client (i.e., no other client assignee information is presented). This is in stark contrast to a generalized checklist that has as previously discussed 15 assignees and corresponding assignee information. Client-based checklists are a significant improvement over traditional practices that rely on generalized checklists. Client-based checklists improve efficiency, and are much easier to follow than generalized checklists, which in turn can improve the quality performance of practitioners in a firm.

Referring back to step 810, system 1500 retrieves a client-based checklist with associated logic responsive to identifying the client from the matter ID and the checklist ID. The logic portion of the checklist can be constructed with an “If then, else” construct. That is, checklists can be, for example, based on a yes or no inquiry. Responding with a yes can lead into a first logical sequence, while responding with a no can lead to different logical sequence. Firm managers can be presented with a GUI for constructing checklists that enables the construction of logical checklists. Once the checklist has been retrieved at step 810 with its corresponding logic, system 1500 can present a first item of the checklist as shown in FIG. 10A. This step would occur nearly instantly after the practitioner enters a matter ID in the upper field.

Each checklist item can have yes/no checkboxes. If the practitioner needs helpful information for responding to the inquiry, an icon with the letter “(i)” can be selected to further describe how to perform a review of the requested item. This feature can be useful to make checklist items succinct for experienced practitioners. If a practitioner selects the yes checkbox, indicating to system 1500 that no error or issue has been detected at step 814, system 1500 proceeds to step 824. If there are additional checklist items detected at step 824, system 1500 proceeds to step 812 to present the next checklist item. To give practitioners a sense of how far along they are in a checklist, system 1500 can also present on the upper right, how many checklist items there are, and which item is being presented.

FIG. 10B depicts a scenario where a practitioner selects the no checkbox, thereby indicating to system 1500 that an error or issue has been detected. When this happens, system 1500 proceeds to step 816 to present the practitioner mitigation options such as shown in FIG. 10B. The mitigation options presented can be tailored to specifically address issues associated with the checklist item. In the present illustration, the mitigation options may include, for example, a comment field that is expandable with a scroll bar. The practitioner can enter in the comment field a description of the issue and corrective action to be taken. To the left of the comment field, system 1500 can present inquiries that help direct system 1500 in processing the detected issue.

For example, the practitioner can be asked whether the detected issue should be reported to paralegals to docket a reminder. The practitioner can also be asked whether it makes sense to continue with the checklist review or terminate the checklist process at this point. In the illustration both inquiries are checked in the affirmative by the practitioner. System 1500 can detect the first response at step 818, and proceed to step 820 to send mitigation information to docketing. The notice can be an email message sent to docketing that includes the mitigation information. Following the email notice, system 1500 can detect at step 822 that the practitioner desires to continue with the review process. Accordingly, system 1500 proceeds to step 824 to determine if other checklists items are present. If so, system 1500 proceeds to step 812 and presents the next checklist item. This process repeats itself until all the checklist items have been exhausted or the practitioner terminates the review process upon detecting another issue. Once the user completes the checklist, system 1500 proceeds to step 826 where it records in a database the responses made by the practitioner while processing the checklist. The checklist is stored according to its matter ID. Additionally, the checklist is associated with the practitioner who performed the review with a time stamp of when the review took place. System 1500 can determine the identification of the practitioner by requiring the practitioner to log into the checklist system.

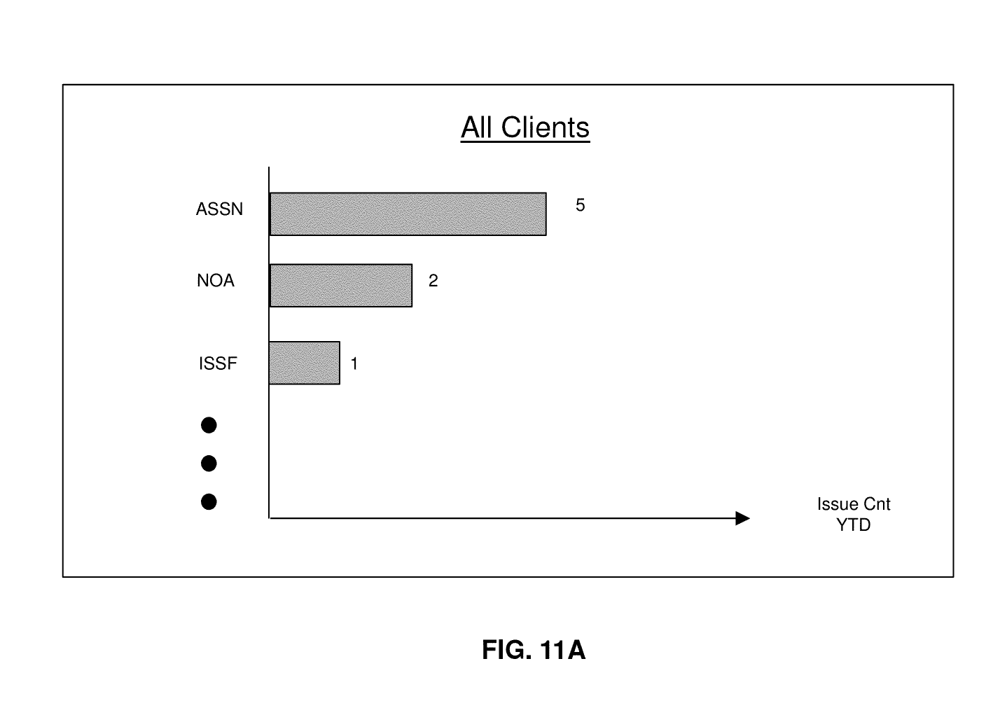

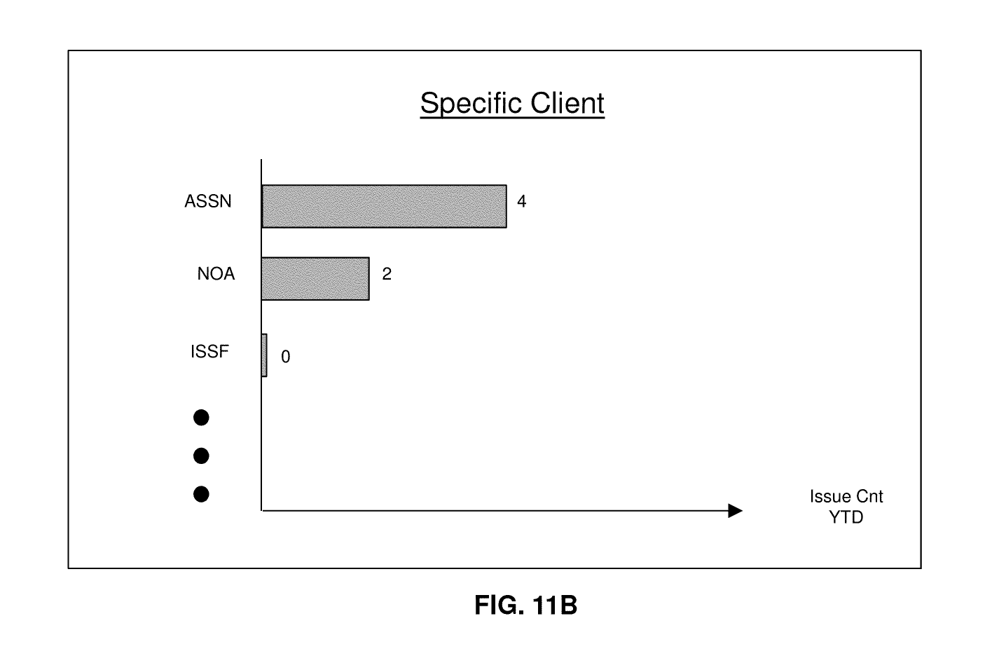

At step 830, system 1500 can receive a request from a firm manager, or system 1500 can be configured to periodically generate reports at steps 832 and 834 which are submitted to the firm manager by email, or presented at a web page accessible to the firm manager. The report can present the firm manager information relating to what issues are being detected by practitioners (when they select a no checkbox) for all clients in the aggregate (FIG. 11A) and/or for specific clients (FIG. 11B). Such reports can be very useful to a firm manager to identify a pattern of issues and to take corrective action to reduce such errors. Corrective action may entail changing prosecution policies, creating new checklists to preempt the issues, and/or updating existing checklists for the same purpose.

Checklists can also be used by billing attorneys to assist them in reviewing the work product of practitioners. For example, billing attorneys can create checklists for reviewing office actions, new patent drafts, and so on. When invoking a checklist for reviewing a practitioner's work product, system 1500 can present in place of the “Enter Matter ID” field shown in FIG. 10A, a “Practitioner ID” field. The billing attorney reviewing the practitioner's work product can enter the initials (or name) of the practitioner in the Practitioner ID field. Alternatively, system 1500 can present a drop-down menu with practitioner names which the billing attorney can select from. The logic-based checklist can present the billing attorney mitigation options to record issues and to instruct the practitioner.

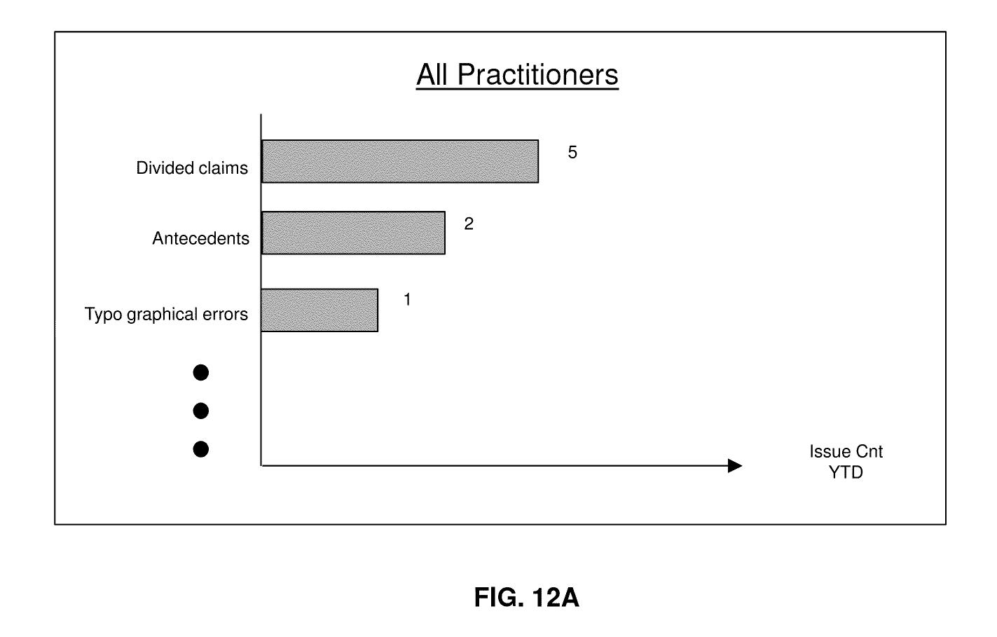

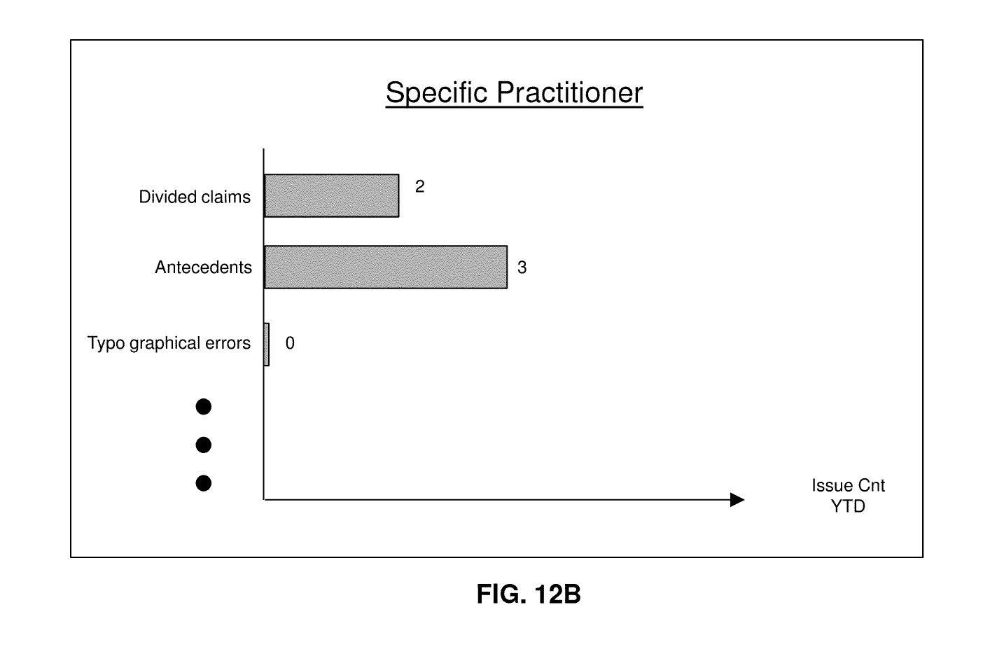

When an issue is detected, the mitigation message can be sent both to docketing and to the practitioner. The mitigation message may require in some instances for the practitioner to resubmit a work product for additional review. Once the checklist is submitted, it can be stored in a database according to the practitioner's ID, and the issuers name (i.e., the billing attorney). As before a time stamp, version number, and so on can be recorded with the checklist. The checklists results submitted by the billing attorney can be later retrieved by system 1500 from its database and presented as an aggregate view of practitioner performance (FIG. 12A) or practitioner performance at an individual level (FIG. 12B). These reports can be used by billing attorneys to mentor practitioners, and as a metric for performance reviews and/or bonuses or compensation formulae.

While for purposes of simplicity of explanation, the respective processes are shown and described as a series of blocks in FIG. 8, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

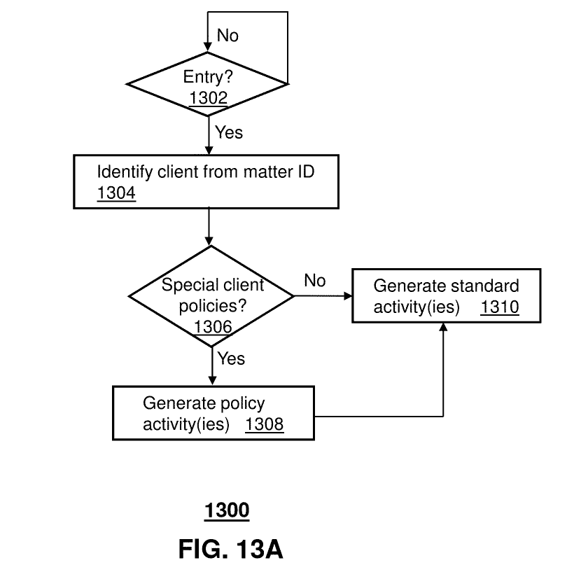

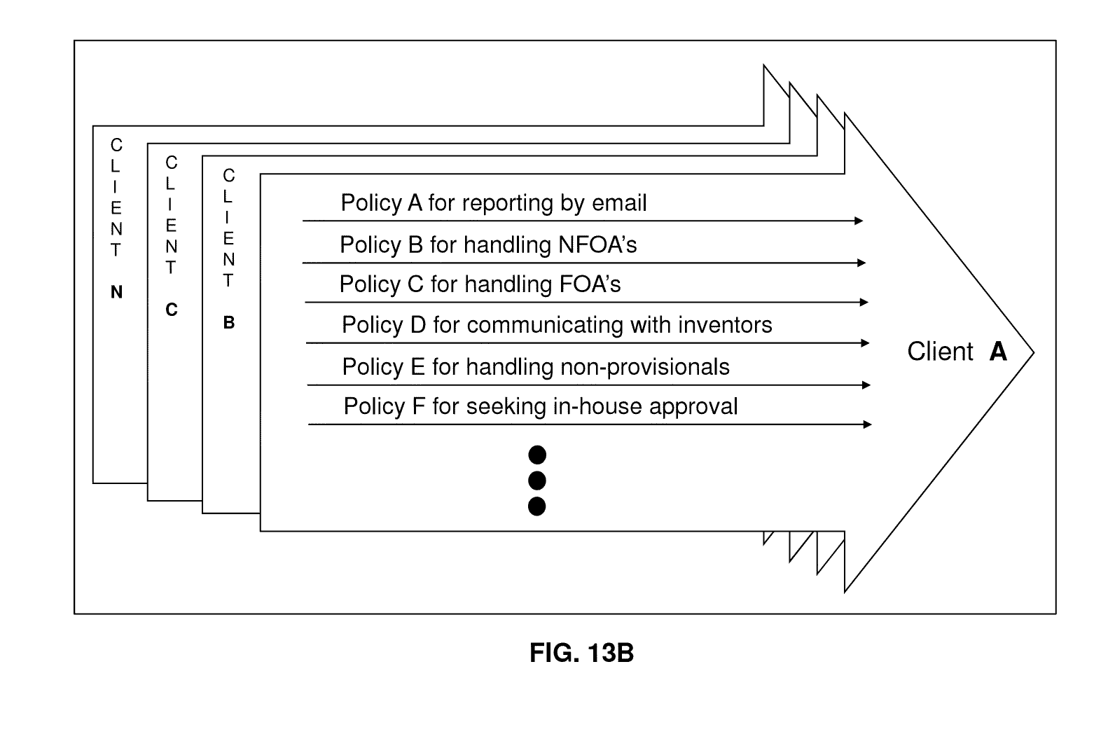

FIG. 13A depicts an example, non-limiting embodiment of a method 1300 for performing policy-based processing of tasks. As described earlier, client-based checklists are more efficient than generalized checklists. This principle can also be used with other project management systems such as docketing systems. Some clients provide comprehensive prosecution guidelines that they distribute to firms managing their portfolios. A docketing system that treats all task activities the same across all clients does not accommodate client policies. Typically under those circumstances, a billing attorney spends a significant amount of their time conveying these policies verbally and/or by email to paralegals and practitioners.

Method 1300 can reduce the burden on billing attorneys to monitor client policies. Assume that system 1500 is also used by a docketing system. Upon detecting a docketing entry at step 1302, system 1500 can proceed to step 1304 where it identifies a client by the client base identifier (e.g., 550) included in the matter record of the docketing system. At step 1306, system 1500 can determine the type of activity being docketed (e.g., a notice of allowance (NOA), a non-final office action (NFOA), a final office action (FOA), a restriction (REST), a new patent application request (NAPP), a continuation application request (CON), etc.). Based on the type of activity being docketed and an identity of the client, system 1500 can determine in step 1306 whether customized activities associated with specific client policies need to be launched.

A billing attorney or docketing administrator can review client policies and thereby customize a docketing template (e.g., FOA) to generate one or more custom activities that represent a policy thread associated with the client guidelines. For example, suppose that a client has a policy that requires practitioners to submit a recommendation within two weeks of the mailing date of an FOA. To accommodate this policy, a billing attorney and/or administrator can create a custom template that that launches from an FOA docketing template when the clients base identifier (e.g., 550) is detected. The custom template when launched can generate a task reminder for a client recommendation that comes due two weeks from the mailing date of the FOA. Contemporaneous with the launch of the custom template, a task reminder for drafting an FOA response is also launched with standard reminder dates (e.g., 3 month deadline without extensions, 1^{st} extension deadline, 2^{nd} extension deadline, 3^{rd} extension deadline, and 6^{th} month deadline) defined by the FOA docketing template. Note if an FOA is received for a different client (i.e., a client with a different client base identifier, e.g., 785), which does not require a recommendation, the custom template for the client recommendation will not launch.

Accordingly, if system 1500 detects at step 1306 a client base identifier (e.g., 550) that is linked to custom activities based on the client's policies, system 1500 proceeds to step 1308 and launches these custom templates to generate one or more custom task activities that are tailored to client policies. At step 1310, system 1500 also launches activities from the system template (e.g., FOA task activities) with reminder dates that are generally associated with patent office rules as described earlier. If, however, system 1500 does not detect at step 1306 that custom templates are linked to the client base identifier (e.g., 785), then system 1500 proceeds to step 1310 and only launches the system template and corresponding system activities.

FIG. 13B depicts the principles embodied by method 1300. Each client may have different policies for reporting emails, office action handling, communicating with inventors, handling new patent applications, seeking in-house approval on certain activities, and so on. A docketing system that links a client base identifier to custom templates can accommodate disparate client policies. By doing so, the docketing system can remove the burden from a billing attorney and/or administrative staff to track such policies by memory or other less efficient techniques.

While for purposes of simplicity of explanation, the respective processes are shown and described as a series of blocks in FIG. 13A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 14 depicts an illustrative embodiment of a communication device 1400. Communication device 1400 can serve in whole or in part as an illustrative embodiment of any system, device, or process that can be used to perform the embodiments described in the subject disclosure, and/or the claims described herein.

Communication device 1400 can comprise a wireline and/or wireless transceiver 1402 (herein transceiver 1402), a user interface (UI) 1404, a power supply 1414, a location receiver 1416, a motion sensor 1418, an orientation sensor 1420, and a controller 1406 for managing operations thereof. The transceiver 1402 can support short-range or long-range wireless access technologies such as Bluetooth, ZigBee, WiFi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 1402 can also be adapted to support circuit-switched wireline access technologies (such as PSTN), packet-switched wireline access technologies (such as TCP/IP, VoIP, etc.), and combinations thereof.

The UI 1404 can include a depressible or touch-sensitive keypad 1408 with a navigation mechanism such as a roller ball, a joystick, a mouse, or a navigation disk for manipulating operations of the communication device 1400. The keypad 1408 can be an integral part of a housing assembly of the communication device 1400 or an independent device operably coupled thereto by a tethered wireline interface (such as a USB cable) or a wireless interface supporting for example Bluetooth. The keypad 1408 can represent a numeric keypad commonly used by phones, and/or a QWERTY keypad with alphanumeric keys. The UI 1404 can further include a display 1410 such as monochrome or color LCD (Liquid Crystal Display), OLED (Organic Light Emitting Diode) or other suitable display technology for conveying images to an end user of the communication device 1400. In an embodiment where the display 1410 is touch-sensitive, a portion or all of the keypad 1408 can be presented by way of the display 1410 with navigation features.

The display 1410 can use touch screen technology to also serve as a user interface for detecting user input. As a touch screen display, the communication device 1400 can be adapted to present a user interface with graphical user interface (GUI) elements that can be selected by a user with a touch of a finger. The touch screen display 1410 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 1410 can be an integral part of the housing assembly of the communication device 1400 or an independent device communicatively coupled thereto by a tethered wireline interface (such as a cable) or a wireless interface.

The UI 1404 can also include an audio system 1412 that utilizes audio technology for conveying low volume audio (such as audio heard in proximity of a human ear) and high volume audio (such as speakerphone for hands free operation). The audio system 1412 can further include a microphone for receiving audible signals of an end user. The audio system 1412 can also be used for voice recognition applications. The UI 1404 can further include an image sensor 1413 such as a charged coupled device (CCD) camera for capturing still or moving images.

The power supply 1414 can utilize common power management technologies such as replaceable and rechargeable batteries, supply regulation technologies, and/or charging system technologies for supplying energy to the components of the communication device 1400 to facilitate long-range or short-range portable applications. Alternatively, or in combination, the charging system can utilize external power sources such as DC power supplied over a physical interface such as a USB port or other suitable tethering technologies.

The location receiver 1416 can utilize location technology such as a global positioning system (GPS) receiver capable of assisted GPS for identifying a location of the communication device 1400 based on signals generated by a constellation of GPS satellites, which can be used for facilitating location services such as navigation. The motion sensor 1418 can utilize motion sensing technology such as an accelerometer, a gyroscope, or other suitable motion sensing technology to detect motion of the communication device 1400 in three-dimensional space. The orientation sensor 1420 can utilize orientation sensing technology such as a magnetometer to detect the orientation of the communication device 1400 (north, south, west, and east, as well as combined orientations in degrees, minutes, or other suitable orientation metrics).

The communication device 1400 can use the transceiver 1402 to also determine a proximity to a cellular, WiFi, Bluetooth, or other wireless access points by sensing techniques such as utilizing a received signal strength indicator (RSSI) and/or signal time of arrival (TOA) or time of flight (TOF) measurements. The controller 1406 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 400.

Other components not shown in FIG. 14 can be used in one or more embodiments of the subject disclosure. For instance, the communication device 1400 can include a reset button (not shown). The reset button can be used to reset the controller 1406 of the communication device 1400. In yet another embodiment, the communication device 1400 can also include a factory default setting button positioned, for example, below a small hole in a housing assembly of the communication device 1400 to force the communication device 1400 to re-establish factory settings. In this embodiment, a user can use a protruding object such as a pen or paper clip tip to reach into the hole and depress the default setting button. The communication device 400 can also include a slot for adding or removing an identity module such as a Subscriber Identity Module (SIM) card. SIM cards can be used for identifying subscriber services, executing programs, storing subscriber data, and so forth.

The communication device 1400 as described herein can operate with more or less of the circuit components shown in FIG. 14. These variant embodiments can be used in one or more embodiments of the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

FIG. 15 depicts an exemplary diagrammatic representation of a machine in the form of a computer system 1500 within which a set of instructions, when executed, may cause the machine to perform any one or more of the methods described above in the subject disclosure. In some embodiments, the machine may be connected (e.g., using a network 1526) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 1500 may include a processor (or controller) 1502 (e.g., a central processing unit (CPU), a graphics processing unit (GPU, or both), a main memory 1504 and a static memory 1506, which communicate with each other via a bus 1508. The processor can include any type of circuitry that enables the processor to execute instructions supplied by a memory device. The computer system 1500 may further include a display unit 1510 (e.g., a liquid crystal display (LCD), a flat panel, or a solid state display. The computer system 1500 may include an input device 1512 (e.g., a keyboard), a cursor control device 1514 (e.g., a mouse), a disk drive unit 1516, a signal generation device 1518 (e.g., a speaker or remote control) and a network interface device 1520. In distributed environments, the embodiments described in the subject disclosure can be adapted to utilize multiple display units 1510 controlled by two or more computer systems 1500. In this configuration, presentations described by the subject disclosure may in part be shown in a first of the display units 1510, while the remaining portion is presented in a second of the display units 1510.

The disk drive unit 1516 may include a tangible computer-readable storage medium 1522 on which is stored one or more sets of instructions (e.g., software 1524) embodying any one or more of the methods or functions described herein, including those methods illustrated above. The instructions 1524 may also reside, completely or at least partially, within the main memory 1504, the static memory 1506, and/or within the processor 1502 during execution thereof by the computer system 1500. The main memory 1504 and the processor 1502 also may constitute tangible computer-readable storage media.

Dedicated hardware implementations including, but not limited to, application specific integrated circuits, programmable logic arrays and other hardware devices that can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 1522 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) can be used by computer system 1500.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system, comprising:
a memory that stores executable instructions; and
a processor coupled to the memory, wherein responsive to executing the instructions, the processor performs operations comprising:
obtaining a list comprising a plurality of tasks;
determining an absolute due date for each task of the plurality of tasks according to a rule associated with each task;
assigning a task value to each task of the plurality of tasks, wherein the task value is based on a first factor of a unit of measure;
determining a workload capacity of each of a plurality of practitioners, wherein the workload capacity is based on a second factor of the unit of measure; and
assigning a portion of the plurality of tasks to each practitioner of the plurality of practitioners according to the workload capacity of each practitioner, the absolute due date of each task, the task value of each task to generate an updated list, or any combination thereof.

2. The system of claim 1, wherein each task of the plurality of tasks has a completion deadline, and wherein the absolute due date for each task is based on a time period before the completion deadline defined by the rule associated with each task.

3. The system of claim 1, wherein the operations further comprise:
obtaining an aggregate list of tasks; and
parsing the aggregate list of tasks according to one or more parsing rules to generate the plurality of tasks.

4. The system of claim 1, wherein the operations further comprise identifying for each practitioner of the plurality of practitioners one or more periods in which a task cannot be assigned to each practitioner, wherein the assigning of the portions of the plurality of tasks is further based on the one or more periods in which the task cannot be assigned.

5. The system of claim 1, wherein the assigning of the portions of the plurality of tasks is further based on a achieving a desired workload balance between the plurality of practitioners.

6. The system of claim 1, wherein the assigning of the portions of the plurality of tasks is further based on a predetermined assignment of one or more tasks to at least one of the plurality of practitioners.

7. The system of claim 1, wherein the operations further comprise identifying for each practitioner of the plurality of practitioners a practitioner due date for each task in the portion of the plurality of tasks assigned to each practitioner.

8. The system of claim 7, wherein the practitioner due date for one or more tasks in the portion of the plurality of tasks assigned to each practitioner occurs sooner than the absolute due dates of the one or more tasks.

9. The system of claim 1, wherein the obtaining of the plurality of tasks further comprises identifying for each practitioner of the plurality of practitioners one or more tasks of the plurality of tasks previously assigned to each practitioner.

10. The system of claim 9, wherein the assigning of the portions of the plurality of tasks is further based on the one or more tasks of the plurality of tasks previously assigned to each practitioner.

11. The system of claim 1, wherein the assigning of the portions of the plurality of tasks further comprises:
identifying one or more tasks not included in the portions of the plurality of tasks that cannot be assigned to the plurality of practitioners; and
classifying the one or more tasks as unassignable one or more tasks.

12. The system of claim 1, wherein each of the plurality of practitioners is assigned a number of units, and wherein the determining the workload capacity is further based on the number of units assigned to each of the plurality of practitioners.

13. The system of claim 12, wherein the determining the workload capacity is further based on one or more periods in which a task cannot be assigned to each practitioner.

14. The system of claim 1, wherein the operations further comprise sorting the plurality of tasks according to the unit value assigned to each task of the plurality of tasks, and wherein the assigning of the portions of the plurality of tasks is further based on the sorting of the plurality of tasks.

15. The system of claim 1, wherein the operations further comprise:
detecting that the assignment of the portion of the plurality of tasks to each practitioner of the plurality of practitioners results in a workload imbalance; and
adjusting the portion of the plurality of tasks assigned to at least two of the plurality of practitioners according to the workload imbalance.

16. The system of claim 1, wherein the unit of measure comprises a billable period for completing a task of the plurality of tasks, or a chargeable fee for completing the task of the plurality of tasks, wherein the first factor comprises a first multiple of the unit of measure, and wherein the second factor comprises a second multiple of the unit of measure.

17. A machine-readable storage device, comprising instructions, wherein responsive to executing the instructions by a processor comprising a circuit, the processor performs operations comprising:
obtaining a list of a plurality of tasks associated with a plurality of client matters;
determining a client due date for each task of the plurality of tasks according to a rule associated with each task;
normalizing the plurality of tasks by assigning a task value to each task of the plurality of tasks, wherein the task value is based on a first factor of a unit of measure;
determining a workload capacity of each of a plurality of practitioners, wherein the workload capacity is based on a second factor of the unit of measure; and
updating the list by assigning a portion of the plurality of tasks to each practitioner of the plurality of practitioners according to the workload capacity of each practitioner, the client due date of each task, the task value of each task, or any combination thereof.

18. The machine-readable storage device of claim 17, wherein the determining the workload capacity is further based on one or more periods in which a task cannot be assigned to each practitioner.

19. A method, comprising:
obtaining, by a system including a circuit, a table comprising a plurality of tasks;
determining, by the system, a due date for each task of the plurality of tasks according to a rule associated with each task;
normalizing, by the system, the plurality of tasks by assigning a task value to each task of the plurality of tasks, wherein the task value is based on a first factor of a unit of measure;
determining, by the system, a workload capacity of each of a plurality of practitioners, wherein the workload capacity is based on a second factor of the unit of measure; and
updating, by the system, the table by assigning a portion of the plurality of tasks to each practitioner of the plurality of practitioners according to the workload capacity of each practitioner, the due date of each task, the task value of each task, or any combination thereof.

20. The method of claim 19, wherein the determining the workload capacity is further based on one or more periods in which a task cannot be assigned to each practitioner.
